(19) United States
(12) Patent Application Publication
(10) Pub. No.: US 2026/0186794 A1
(43) Pub. Date: Jul. 2, 2026

(54) WATCH FACE CREATION SYSTEM PROVIDING USER INTERFACE

(71) Applicant: APPOSTER INC., Seoul (KR)

(72) Inventor: Sung Hyun Kyung, Gimpo-Si (KR)

(73) Assignee: APPOSTER INC., Seoul (KR)

(21) Appl. No.: 18/564,874

(22) PCT Filed: Nov. 29, 2022
(86) PCT No.: PCT/KR2022/019083

§ 371 Date: Nov. 28, 2023

(51) Int. Cl. G06F 9/451; G06F 1/16; G06F 1/3203; G06F 3/0484

(52) U.S. Cl. CPC G06F 9/451; G06F 1/163; G06F 1/3203; G06F 3/0484

(57) ABSTRACT

This specification describes a watch face creation system. According to the present disclosure, by providing a user interface for creating a watch face reflecting user settings, a user's convenience for creating a watch face capable of freely expressing his or her personality by reflecting a user's preference or taste may be improved, and a technical means for promoting the creation of a customized watch-face and expanding the market for a customized watch-face created by a non-professional may be provided.

### TECHNICAL FIELD

The present description relates to a watch face creation system that provides a user interface for creating a watch face.

### BACKGROUND ART

With the advent of smartwatches, the hardware-oriented watch industry is being reorganized around content, and for example, the mid- to low-priced market, which accounts for 80% of the global market, is changing around smartwatches, and by providing an interface for customizing watch faces as core content of smartwatches, research on technical means that may promote the creation of customized watch-faces reflecting user references or tastes and expand the market for customized watch-faces created by non-professional is being actively conducted.

### DISCLOSURE

### Technical Problem

An example of the present disclosure may include a watch face creation system that provides users to express their individuality freely to improve user convenience in the creation of a watch face. This is achieved by the provision of a user interface that reflects individual user preferences or tastes via customizable settings for creation of watch faces.

An example of the present disclosure may include a watch face creation system that provides technical means for promoting the creation of customized watch face and expanding the market for customized watch faces created by non-professionals.

### Solution to Problem

To achieve the above and other purposes, a watch face creation system of the present disclosure includes: a processing server providing a user interface for selecting a type of information rendered on a watch face, including first-type information corresponding to real-time status data and second-type information corresponding to design data, and for selecting a display element assigned to a selected type of information, wherein the processing server outputs a display element reflecting real-time status data on a user interface screen via a set of output functions that includes a first output function of outputting a first parameter by using the status data as a first factor and a second output function of outputting rendering of a display element by using a user's setting value regarding detailed design of the display element assigned to the real data; regarding a code including a set of output functions constantizing the second factor, i) converts the code into a code according to a smartwatch in associated with a user's ID and transmits a converted code to the smartwatch; and ii) stores the code in a database in associated with a user's ID.

### Effects of Invention

According to the present disclosure, it may provide technical means that enhance user convenience in the creation of watch faces, allowing users to freely express their individuality by reflecting their preferences or tastes through a user interface for creating watch faces that reflect user settings, and promote the creation and customized watch faces and expand the market for customized watch faces created by non-professionals.

### BRIEF DESCRIPTION OF DRAWINGS

FIG. 1 illustrates a block diagram of the overall structure of a watch face creation system according to an example of the present disclosure.

FIG. 2 illustrates a view of an example of a user interface screen for setting a watch face according to an example of the present disclosure.

FIGS. 3A and 3B illustrate diagrams showing, in an example of the present disclosure, examples of different forms of display elements (e.g., battery text and hand batt) assigned to status data of remaining battery capacity, classified as a first-type information.

FIG. 4 illustrates a diagram showing, in an example of the present disclosure, a general overview of the process in which the rendering of a display element assigned to the current time is output through the first and second output functions.

FIG. 5 illustrates a schematic diagram showing, in an example of the present disclosure, the process in which the rendering of a display element assigned to weather is output through the first and second output functions.

FIGS. 6 and 7 illustrate diagrams showing examples of display elements assigned to classes from 00 to 18 for weather output through the first output function in FIG. 5, and the corresponding categorization conditions for each class.

FIG. 8 illustrates a schematic diagram showing, in an example of the present disclosure, the process in which the rendering of a display element assigned to the remaining battery capacity is output through the first and second output functions.

FIG. 9 illustrates a diagram showing an example of a user interface screen for loading digital contents stored in the local area.

FIG. 10 illustrates a schematic diagram showing a CNN network that is applicable in an image processing module 240 and a similarity calculation module 260 as part of the configuration of a processing server 200 according to an example of the present disclosure.

FIG. 11 illustrates a diagram of showing an example of a user interface screen displaying completed user settings for a watch face, showing a phase where a user interface for Non-Fungible Token (NFT) registration or minting is presented based on a user's selection.

FIG. 12 illustrates a diagram of showing an example of a user interface screen displaying completed user settings for a watch face, showing a menu regarding the availability of permission for secondary processing or editing based on a user's selection.

FIG. 13 illustrates a block diagram showing a schematic configuration of the Ethereum network and a node constituting the Ethereum network, i.e., a mining node or full node.

FIG. 14 illustrates a diagram showing an example of a series of processes, through a web page managed by a processing server 200, of registering a watch face as a product, completing the sale based on a buyer's selection, listing and displaying a group of watch faces owned by the buyer, and applying a watch face selected by the user to a smartwatch 300.

FIG. 15 illustrates a schematic diagram showing the process where a portion of the sales revenue transferred from a buyer account A10 to a contract account A20 is distributed to a processing server account A30 and an original creator account A40 as respective commission fees and creation support funds in accordance with the terms of the contract.

FIG. 16 illustrates a diagram showing an example of displaying different pairs of watch faces, each in a screen-on state and a screen-off state, respectively.

FIG. 17 illustrates a diagram showing an example of a watch face in a screen-on state and a watch face in a screen-off state, each achieved with a reduced power consumption ratios by applying different processes.

FIG. 18 illustrates a diagram showing first through fifth processes (S1 to S5) of a processing server 200 creating a watch face in a screen-off state by editing a watch face in a screen-on state.

FIG. 19 illustrates a block diagram showing the overall structure of a smartwatch according to an example of the present disclosure.

### BEST MODE FOR CARRYING OUT THE INVENTION

A watch face creation system of the present disclosure includes a processing server providing a user interface for selecting a type of information rendered on a watch face, including first-type information corresponding to real-time status data and second-type information corresponding to design data, and for selecting a display element assigned to a selected type of information. The processing server outputs a display element reflecting real-time status data on a user interface screen via a set of output functions that includes a first output function of outputting a first parameter by using the status data as a first factor and a second output function of outputting rendering of a display element by using a user's setting value regarding detailed design of the display element assigned to the real data. Regarding a code including a set of output functions constantizing the second factor, the processing server: i) converts the code into a code according to a smartwatch in associated with a user's ID and transmits a converted code to the smartwatch; and ii) stores the code in a database in associated with a user's ID.

For example, the processing server may provide a menu for loading digital content on a user interface screen to incorporate the digital content requested by the user into a display element on the watch face while providing a selection menu for the user's selection of the standardized display element through the user interface screen.

For example, the processing server may limit the loading of digital content incorporated into the display element to a display element assigned to the second-type information.

For example, the processing server may limit digital content incorporated into the display element to image data.

For example, the processing server may limit the loading of digital content incorporated into the display element to the background of a watch face that corresponds to the lowest sub-layer among different sub-layers rendering various display elements forming the watch face.

For example, the processing server obtains digital content incorporated into a display element, activates an image processing module that assesses the potential infringement with well-known brands using the obtained digital content as input, and, depending on the output of the image processing module that calculates the similarity between at least a portion of the digital content and well-known brands, may prohibit the incorporation of the digital content into the display element, asking the user to select new digital content through the user interface screen.

For example, upon obtaining a watch face that has been set up by the user, the processing server recognizes the lowest sub-layer among different sub-layers where various display elements forming the watch face are rendered as a sub-layer where a new display element generated digital content is rendered based on the user's selection regarding the loading of digital content and may input the lowest sub-layer into the image processing module.

For example, the image processing module may include a Convolution Neural Network (CNN) network that includes weights learned by using visual images of well-known brands as training data and outputs a predicted probability of similarity between at least some of the digital content and well-known brands by inputting the digital content.

For example, according to the user's request, the processing server may output a watch face stored in a database in association with a user's ID on the user interface screen to allow editing of the corresponding watch face.

For example, the processing server may provide a selection menu for deleting or adding a display element that forms a pre-edited watch face for the purpose of editing the watch face. Additionally, it may provide a menu for loading standardized display elements for adding the display element or digital content from the user. However, the loading of digital content to be added to the display element may be limited to a display assigned to the second-type information.

For example, according to a user's request, the processing server may output a pre-edited watch face stored in association with the user's ID on the user interface screen as an editable watch face. However, if an initial watch face created before editing is a watch face registered as an NFT, and the user information stored in connection with the user's ID does not match the original creator information of the initial watch face created before editing, on a user interface screen for editing the watch face, when the edited watch face is registered as an NFT and the NFT registered watch face is sold, a notification message may be sent to indicate that a part of the sales revenue may be supported as a creation support fund.

For example, the processing server may set a watch face with completed user setting as a watch face in a screen-on state and create a watch face in a screen-off state paired with the watch face in a screen-on state according to the user's request.

For example, according to the transition from the watch face in a screen-on state to a watch face in a screen-off state, a smartwatch where the watch face in a screen-off state is rendered may be shifted to the power saving mode of Always On Display (AOD).

For example, the processing server may create a watch face in a screen-off state by adjusting energy factors of the display area or luminance that affect the power consumption of the screen, such that the watch face in a screen-off state is adjusted to meet a pre-set power consumption criterion.

For example, the power consumption criterion may be set as a ratio of the number of pixels turned on when the watch face is in a screen-off state among the total number of pixels on the effective screen of the smart watch in which the watch face is rendered.

For example, the processing server may preferentially adjust the energy factor of the display area or luminance for the corresponding display element according to the type of information assigned to each of a plurality of elements forming the watch face.

For example, the processing server may create a watch face in a screen-off state that meets a power consumption criterion by first adjusting a display element assigned to the second-type information before adjusting a display element assigned to the first-type information among display elements assigned to the first-type information corresponding to real-time status data and the second-type information corresponding to the design data.

For example, the processing server may sequentially apply first through third processes to create a watch face in a screen-off state that meets power consumption criterion and determines whether to meet the power consumption criterion upon completion of each process:
i) first process of reducing a display area of a display element assigned to the second-type information;
ii) second process of reducing or removing luminance of the display element assigned to the second-type information from the watch face in a screen-off state; and
iii) third process of sequentially reducing or removing, among display elements assigned to the first-type information, luminance of a corresponding display element based on the user's selection or in decreasing order of variability.

For example, the processing server may create a watch face in a screen-off state by adjusting the energy factor of the display area or luminance that affects the power consumption of the screen from the watch face in a screen-on state according to the user setting, but it does not allow the watch face in the screen-off state depending on whether the watch face in the screen-off state reflecting the user setting meets, and may sequentially provide a guide for the user's reset by requesting the user's reset for the watch face in the screen-off state or requesting the user's reset or requesting the user's reset according to the following first through third processes:
i) first process of reducing a display area of a display element assigned to the second-type information;
ii) second process of reducing luminance of the display element assigned to the second-type information or removing from the watch face in a screen-off state; and
iii) third process of sequentially reducing luminance of a corresponding display element or removing from the watch face in a screen-off state, according to the user's selection or in order of least change over time among display elements assigned to the first-type information.

For example, the processing server may provide an interface for NFT registration or NFT minting that stores a watch face reflecting a user setting on the blockchain according to a request of the user.

For example, the processing server may access the network of the blockchain according to a request of the user and stores the storage location and owner information of the watch face for NFT registration on the blockchain in the form of transaction or smart contract, but uses the storage location where the watch face is stored on the database connected to the processing server as a location stored on the blockchain, and the user information stored on the processing server in associated with the user's ID as owner information stored on the blockchain.

For example, the processing server may register a watch face product on a web page managed by the processing server according to a request of the user, and indicate that it is an NFT registered watch face product on the product description or product appearance.

For example, the processing server may create a smart contract that allocates part of the sales revenue of the NFT registered watch face as a consignment sales fee of the processing server and store it on the blockchain.

For example, the processing server may incorporate the contents of the processing server's consignment sales fee into the contract contents of the smart contract while creating a smart contract for NFT registration or minting.

For example, the progressing server may call the smart contract while transferring the sale revenue to a contract account of the smart contract, along with the sale of an NFT registered watch face through a web page managed by the processing server so that it is automatically transferred to each processing server and the owner's account with a divided amount between the consignment sales fee incorporated into the contract content and the owner of the NFT registered watch face.

For example, if original creator information of a pre-edited watch face registered as an NFT and the user information of a post-edited watch face do not match each other, the processing server may incorporate the content of allocating part of the sales revenue as creation support fund to the original creator as a contract content while creating an NFT registration or minting for the post-edited watch face according to a request of the user.

For example, the processing server may transfer information on a specific distribution ratio of the sales revenue to the contract account while transferring the sales revenue to the contract account of a smart contract, and automatically transfer it to respective accounts of the original creator and owner at a split amount between the creation support fund included in the contract content and the owner of the NFT registered watch face.

For example, the processing server may operate a similarity calculation module connected to the processing server with two inputs: a pre-edited watch face and a post-edited watch face, and determine the specific distribution ratio of creation support fund among the sales revenue according to the similarity between the pre-edited watch face and the image of the post-edited watch face, i) incorporating it into the contract content of the smart contract for NFT registration or minting for the post-edited watch face, or ii) including a function on the specific distribution amount in the contract content of the smart contract for NFT registration or minting, and along with the sale of the NFT registered watch face, information on the distribution ratio transmitted as a factor of a function related to the distribution amount may be delivered to the contract account of the smart contract.

For example, a code for creating the pre-edited watch face and the post-edited watch face includes an output function that outputs a parameter that determines the rendering of a display element using real-time status data as a factor, and the similarity calculation module may calculate the similarity between visual images by inputting the image of the pre-edited watch face and post-edited watch face rendered to reflect the same status data by obtaining real-time status data.

For example, the similarity calculation module includes a Convolution Neural Network (CNN) network that calculates feature vectors extracted from visual images of a pre-edited watch face and a post-edited watch face and outputs similarity between feature vectors output from the CNN network as similarity between the pre-edited watch face and the post-edited watch face.

### MODE FOR CARRYING OUT THE INVENTION

Hereinafter, a watch face creation system according to a preferred example of the present disclosure will be described with reference to the attached drawings.

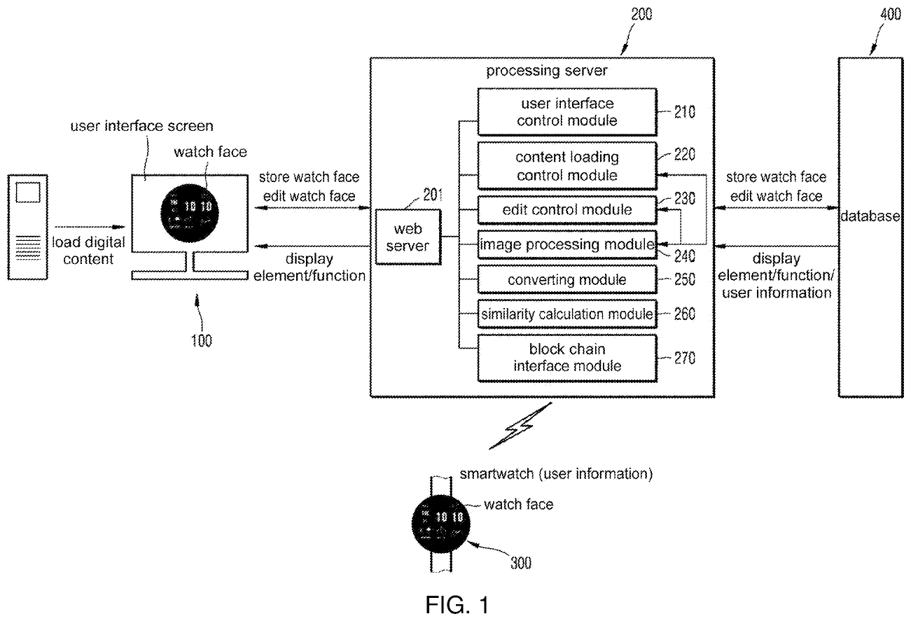

FIG. 1 illustrates a block diagram of the overall structure of a watch face creation system according to an example of the present disclosure.

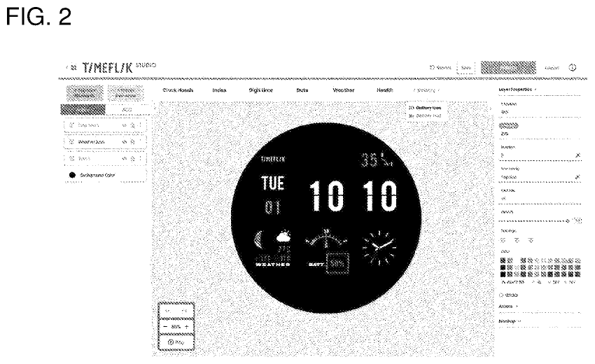

FIG. 2 illustrates a view of an example of a user interface screen for setting a watch face according to an example of the present disclosure.

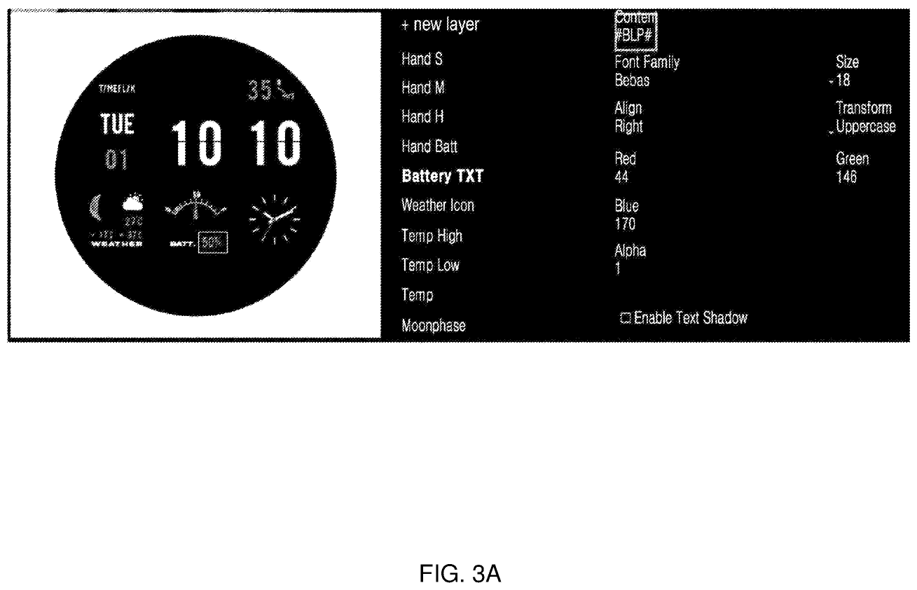

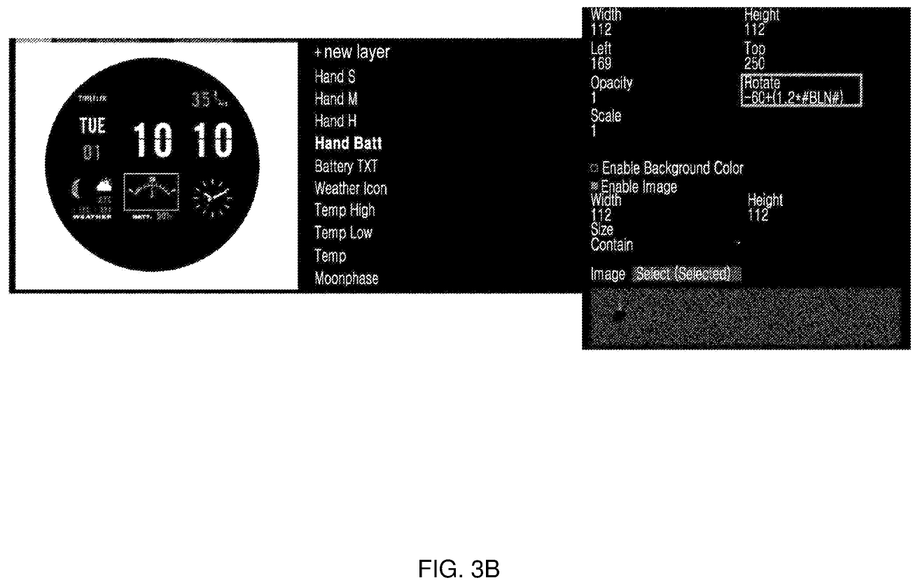

FIGS. 3A and 3B illustrate diagrams showing, in an example of the present disclosure, examples of different forms of display elements (e.g., battery text and hand batt) assigned to status data of remaining battery capacity, classified as a first-type information.

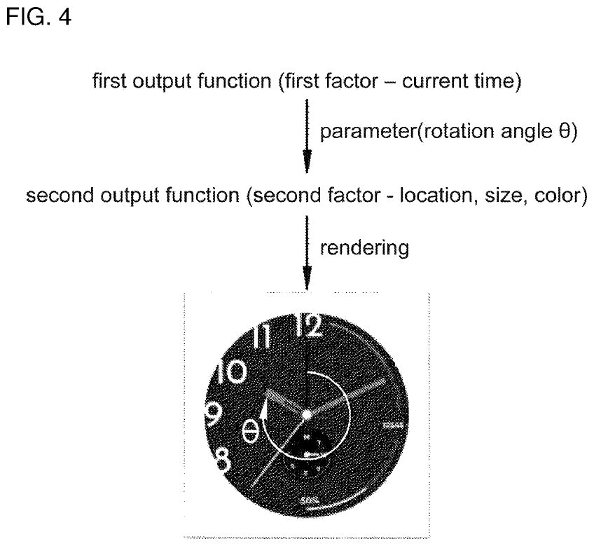

FIG. 4 illustrates a diagram showing, in an example of the present disclosure, a general overview of the process in which the rendering of a display element assigned to the current time is output through the first and second output functions.

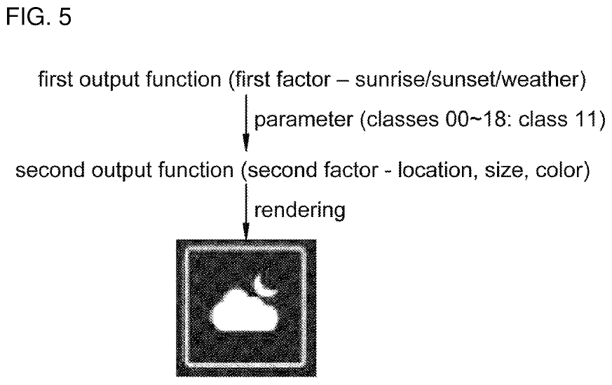

FIG. 5 illustrates a schematic diagram showing, in an example of the present disclosure, the process in which the rendering of a display element assigned to weather is output through the first and second output functions.

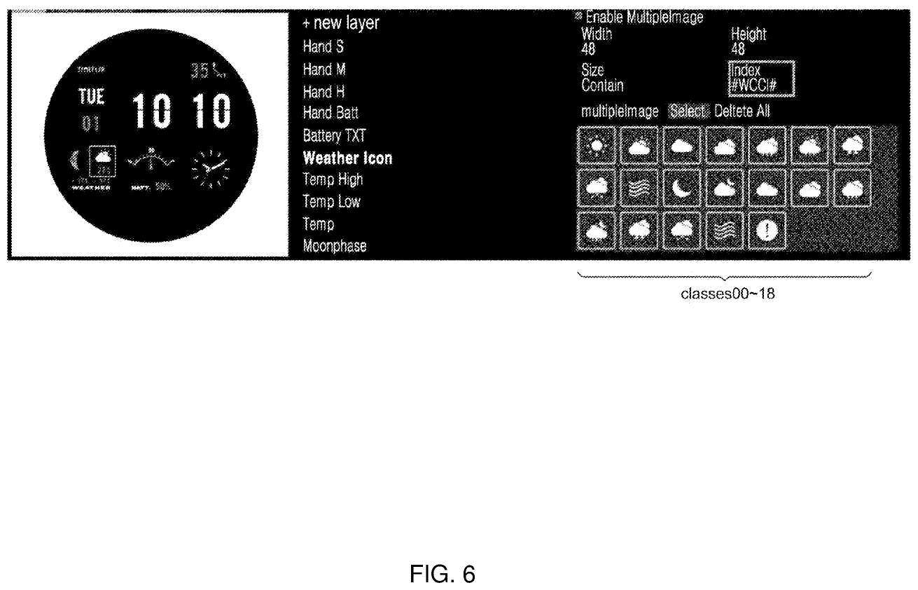

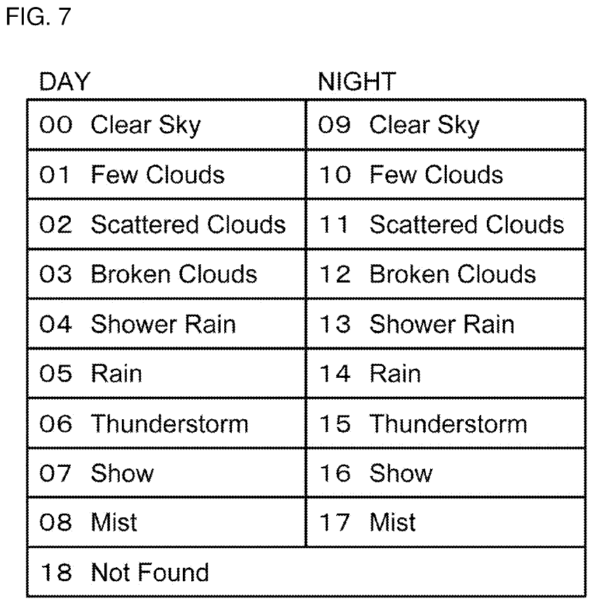

FIGS. 6 and 7 illustrate diagrams showing examples of display elements assigned to classes from 00 to 18 for weather output through the first output function in FIG. 5, and the corresponding categorization conditions for each class.

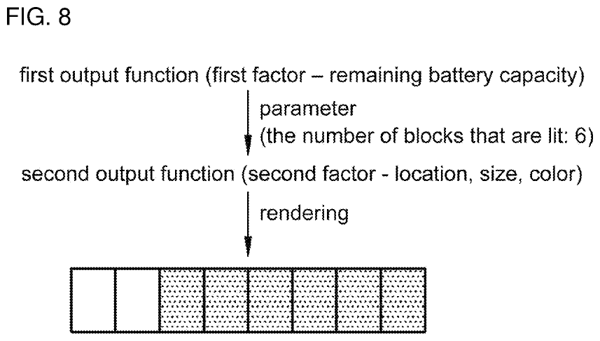

FIG. 8 illustrates a schematic diagram showing, in an example of the present disclosure, the process in which the rendering of a display element assigned to the remaining battery capacity is output through the first and second output functions.

Referring to drawings, a watch face creation process according to an example of the present disclosure may include a processing server 200 that provides a user interface for selecting a type of information rendered on the watch face, including a first-type information corresponding to real-time status data and a second-type information corresponding to design data and selecting display elements assigned to the selected type of information. The processing server 200 outputs display elements that reflect real-time status data on a user interface screen using a set of output functions including a first output function that outputs a parameter, using the status data as a first factor and a second output function that outputs rendering of a display element, using a user setting value for the detailed design of the display elements assigned to the status data as a second factor.

Regarding a code that includes the set of output functions with the second factor as a constant, the processing server 200: i) converts the code according to a smartwatch 300 associated with the user's ID and transmits the converted code to the smartwatch 300, and ii) stores it in a database 400 in association with the user's ID.

In an example of the present disclosure, the processing server 200 may send a web document according to a request from a communicatively connected user terminal 100 and may output a user interface screen on the user terminal 100 through a web browser running on the user terminal 100. According to various examples of the present disclosure, the processing server 200 may output a user interface screen on the user terminal 100 through a web document or may transmit, according to a user's request in response to access path linked in a web document or a click event on connection paths linked in a web page implemented on the user terminal 100 through a web document, a document or file stored in the database 400 in associated with the processing server 200 and output a user interface screen on the user terminal 100.

In an example of the present disclosure, providing a user interface by the processing server 200 to create a watch face that reflects user settings may refer to providing an interface for user settings, such as user settings for selections regarding the type of information rendered on a watch face, or user settings for display elements assigned to the selected type of information. In an example of the present disclosure, it may be understood that an interface for user settings is provided by the processing server 200, rather than the user terminal 100 in that the processing server 200 receives a user's request via the user interface screen in cooperation with the user terminal 100, which is communicatively connected to the processing server 200 to implement the user interface screen, and performs a response process to respond to the user's request, while the user terminal 100 implements a user interface screen or performs a response process to respond to the user's request through the user interface screen via data transmission of a document or file, including commands, functions, image data, and access paths to image data, from the processing server 200.

In an example of the present disclosure, the processing server 200 may output a watch face that reflects user settings in real time via a user interface screen to enable user confirmation. When the user setting via the user interface screen is completed, the user terminal 100 operating the user interface screen or the processing server 200 connected to the user terminal 100 may generate a code for creating a watch face reflecting the user setting. The processing server 200 may convert the generated code into a code suitable for an Application Programming Interface (API) with an operating system 301 of the smartwatch 300 retrieved from the user information stored in connection with the user's ID and may transmit the converted code to the user's smartwatch 300 such that the watch face reflecting the user settings is rendered on the smartwatch 300.

The code for creating a watch face may include functions, commands, image data, or access paths to image data used to create respective display elements forming the watch face. For example, the code for creating the watch face may include output functions used to render predetermined forms of display elements on the watch face through user settings by obtaining real-time information, e.g., status data related to time, weather, health, exercise, and remaining battery capacity, generated from the operating system 301 of the smartwatch 300 or an application module running on the operating system 301 of the smartwatch 300, image data rendered on the watch face as decorative design data rather than real-time information, or access paths to image data.

In an example of the present disclosure, display elements rendered on a watch face may refer to display elements assigned to each of the types of information selected through user settings, including a first-type information corresponding to status data that changes continuously or incrementally over time, such as time, weather, health, exercise, and remaining battery capacity, and a second-type information corresponding to decorative design data rather than real-time information, such as the watch face's background, and may include any form of display element output to the watch face to display the type of information selected via the user settings.

In an example of the present disclosure, display elements rendered on a watch face may include dynamic displays in which the shape of a display element rendered on the watch face changes over time by reflecting real-time information (e.g., first-type information corresponding to status data). In this sense, the display element implemented on a watch face may not exclusively refer to a static display that does not involve a change in shape over time, or may not exclusively refer to a dynamic display that changes in a predetermined pattern over time without reflecting real-time information. For example, a display element assigned to status data, such as time, may correspond to a dynamic display that reflects real-time information, rather than a dynamic display that changes over time in a predetermined pattern without reflecting real-time information. For example, even if the dynamic display displayed on the watch face has a dynamic motion that changes in a uniform pattern over time, when the operation power of the watch face is switched from OFF to ON, the dynamic display assigned to the time-type information obtains real-time status data (“current time”) from the operating system 301 of the smartwatch 300 on which the watch face is displayed or an application module running on the operating system 301 and renders a display element reflecting the real-time status data (“current time”) on the watch face using the status data (“current time”) as a factor in accordance with the status data obtained in real time and using a display element determined by user settings. In other words, in a dynamic display that displays time-type information, the rendering of the display element displayed on the smartwatch 300 may be updated using an output function that takes, as an argument status, data regarding the current time, which is output from the operating system 301 of the smartwatch 300 or an application module running on the operating system 301, or by using a parameter (e.g., rotation angle of the hour or minute hands) obtained from the output function based on the status data regarding the current time.

In an example of the present disclosure, the rendering of the display element may change based on a parameter that is obtained from an output function that takes real-time status data as a factor. In other words, the rendering of a display element implemented on the watch face and an output function for creating a watch face may be interconnected through a suitable parameter. The status data (“current time”) obtained in real time is input, and the output value output from the output function that takes status data as an factor may correspond to a parameter (e.g., rotation angle of the hour or minute hand) that determines the rendering of the display element displayed on the watch face. The input of the parameter may result in a display element reflecting real-time status data being displayed on the watch face. For example, in an example of implementing a dynamic display in the form of an analog clock on a watch face, status data regarding the current time obtained from a smartwatch 300 or an application running on the smartwatch 300 may render a display element reflecting the current time on the watch face via an output value of an output function corresponding to rotation angles for the position of the hour and minute hands on separate circles, each representing 360 degrees for 24 hours and 60 minutes, respectively, based on the status data regarding the current time (corresponding to a parameter determining the rendering of a display element or a parameter connecting the output function and the rendering of a display element). In this case, the output value of the output function taking the real-time status data as input may correspond to a parameter for rendering the display element, for example, the output function may output the value of a parameter, which is a rotation angle for the hour and minute hands corresponding to the current time, as a parameter for rendering of a display element.

In an example of the present disclosure, status data that can transmit real-time information via rendering of a display element or a first-type information corresponding to the status data may include status data on time, weather, health, exercise, and remaining battery capacity. For example, the weather status data may be rendered into a display element that includes 19 classes selectively combined with icons representing the sun and moon to distinguish day and night, and a plurality of icons representing sun, clouds, rain, snow, thunder, and fog to reflect weather conditions. Among 19 classes (classes 00 through 18), which selectively display a plurality of icons reflecting the sun and moon for day and night distinction, or a plurality of weather conditions, a display element reflecting the current weather may be rendered via an output function, based on an obtained status data about the current weather and sunrise/sunset conditions, matches the current weather to one of the 19 classes, thereby reflecting the current weather information. For example, an output function for rendering display elements assigned to weather-type information may determine the class to which the current weather belongs according to the classification criteria in advance to classify the current weather into any one of 19 classes from status data on weather conditions, such as sunrise, sunset, rain, and snow, obtained in real time, and may output the determined class, for example, the unique number of the determined class (00˜18) as a parameter value, and a class matched through the parameter may be rendered on the watch face. For example, the output function may determine the current weather's classification among the 19 weather classes, select the determined class, and render it on the watch face as the display element assigned to the weather.

For example, the status data regarding the remaining battery capacity may calculate the number of lighting blocks that meet the current battery remaining capacity via an output function that calculates the number of blocks that are lit (each lighting block consists of a set of pixels) arranged to display the remaining battery capacity. The output function may calculate the number of lighting blocks that meet the current battery remaining capacity by using status data on the remaining battery capacity obtained from the operating system 301 of the smartwatch 300 or the application running on the operating system 301.

In an example of the present disclosure, a output function that determines the rendering of a display element may output a parameter to determine the rendering of the display element to reflect real-time information, as described above, rather than including an arrangement of brightness values assigned to each position coordinate on the user interface screen or the screen of the smartwatch 300. In this sense, a display element implemented on the watch face or a code for creating a watch face that includes a plurality of display elements on the watch face is not just simple image data but may be considered as digital content implemented as a collection of output functions for rendering display elements, including a plurality of output functions.

In an example of the present disclosure, the processing server 200 may provide, via the interface screen for user settings for selections regarding different types of information (weather, time, health, exercise, remaining battery capacity, etc.) and selections regarding different display elements to be assigned to each type of information, each of which may be associated with a unique output function. For example, the processing server 200 may receive the user settings regarding the selection of different types of information through an interface screen for the user settings implemented on the user terminal 100, and may also receive from the user input regarding a selection of different display elements for displaying selected types of information.

In an example of the present disclosure, the processing server 200 may transmit to the user terminal 100 a code for creating the corresponding display element, including an output function that is matched to the display element selected by the user, and may search the database 400 associated with the processing server 200 and transmit to the user terminal 100 a code for generating the corresponding display element, including an output function retrieved from the database 400.

In an example of the present disclosure, according to a request from a user, the processing server 200 may transmit output functions for generating the requested display elements from the database 400 associated with the processing server 200 to the user terminal 100 on which the user interface screen is implemented. In an example of the present disclosure, the processing server 200 may transmit an output for creating a display element requested from a database 400 associated with the processing server 200 to a user terminal 100 implemented on the user interface screen according to a user's request. In various examples of the present disclosure, the processing server 200 may transmit an output function for generating each requested display element in the form of a response in response to a user's request through the user interface screen, or may output the display element requested from the user on the user interface screen, without communicating with the processing server 200, from an application installed on the user terminal 100 through an application running on the user terminal 100 implementing a user interface screen, for example, a document or file containing data regarding a plurality of function sets.

Through the present disclosure, a code for creating a watch face where a display element or a plurality of display elements are rendered may include an output function that outputs a parameter determining the rendering of the display element. In an example of the present disclosure, the output function's outputting a parameter determining the rendering of a display element may refer to outputting numeric data that changes variably depending on real-time status data. For example, an output function may output a parameter of a rotation angle of an hour hand or a minute hand from the status data of the current time, output a parameter of the number of blocks that are lit among a plurality of lighting blocks, output a parameter of a unique number of a class corresponding to weather from the status data of the weather, and each parameter output from the output function may determine display rendering reflecting the corresponding status data.

Specifically, the output function may include a first output function that outputs a parameter for determining rendering of a display element using real-time status data as a first factor, and a second output function that outputs rendering of a display element using a user setting for rendering details of the display element reflecting the parameter as a second factor. In an example of the present disclosure, the second output function may refer to an output function that renders a display element by reflecting a user settings for rendering details, with a second factor being a user setting for rendering details, such as the position, size, or color of a display element, specified as the user setting for the rendering detail, reflecting the user setting for the rendering detail in order to render the display element reflecting a parameter output from the first output function. For example, the second output function may output a rendering of a substantially corresponding display element by taking user settings for rendering details as a second factor, derived from a parameter output of the first output function taking status data as a first factor, and may include, for example, an arrange of color/luminance values for each position coordinate in the image coordinate system set on the screen to output rendering of a corresponding display element.

In an example of the present disclosure, a second factor where the user settings or the user settings regarding the details of the rendering is stored is a variable in which the user settings is stored only during the operation of the user interface screen or the application driving the user interface screen, and the rendering of the corresponding display element may be output through the second output function. For example, after the end of the user interface screen or the application running the user interface screen, it may be constantized through the application or processing server 200, and until the user settings changes later, the user settings on the rendering details of the display element may be constant.

For example, in the display element assigned to the status data on the weather, the first output function may classify the current weather into one of 19 classes set in advance from the status data on the current weather, output the unique number of the classified class as a parameter, and the second output function may render the image of the class output from the first output function to a display element according to the rendering details designated by the user setting using the user setting on the rendering details as a second factor. For example, an image of a class determined according to a parameter output from the first output function may be output in a designated positions, size, and color by reflecting the user setting on the rendering details, and the second factor in which the user setting is stored is designated as a variable during the operation of the application that implements the user setting or the user interface screen, and the corresponding display element may be output as a rendering reflecting the user setting. However, once a user interface screen or an application that implements the user interface screen is terminated, e.g., after a click event of Apply button on the user interface screen after the user setting has been completed, the second factor is constantized by the application or processing server 200 running the user interface screen so that the rendering details of a display element may be maintained as set by the user until the user resets it later. For example, in an example of the present disclosure, the outputting of rendering of the display element by the second output function may refer to the outputting image data including an array of color/brightness values for each coordinate position on the image coordinate system for rendering of the display element, but for example, it may output such image data in cooperation with another application, which is an application other than an application driving a user interface screen, running on the user terminal 100. For example, the second output function may output image data including an arrangement of color/brightness values assigned to position coordinates set on the screen for rendering of the corresponding display element (e.g., values of R, G, B on RGB color space or values of Y, Cb, Cr on YCbCr color space), and may output such image data through cooperation with other applications running on the user terminal 100. In other words, the first output function may output a parameter that determines rendering of the display element using status data as a first factor, and the second output function may output rendering of a display element using user setting regarding rendering details as a second factor.

In an example of the present disclosure, the set of output functions for implementing display elements assigned to real-time status data may include a first output function that outputs a parameter that determines rendering of a display element by considering real-time status data as a first factor, and a second output function that outputs rendering of a display element determined by a parameter output from the first output function, but outputs rendering of a display element by considering user settings regarding rendering details as a second factor.

For example, the first factor may correspond to status data obtained from an operating system 301 of a smartwatch 300 and so on, and the first output function may output a variable parameter by reflecting the current status using real-time status data as a first factor. The second factor is a constant value designated through a user's setting for rendering details and does not change on the once created watch face, or it may be input through the user's setting and input to the second output function as a constant value until the user's settings are changed. For example, the second factor determines the detailed rendering design of a display element, and is a user's setting regarding the location, size, color, font size, etc. of the display element on the watch face, and is maintained at a constant value (constantization) until the user's reset is completed through the user interface screen, so that the detailed rendering of a display element reflecting the user's setting may be kept constant over time. The first and second factors may correspond to factors that are input to the first and second output functions, respectively. The first factor may correspond to a factor input to the first output function as real-time status data obtained from the operating system 301 of a smartwatch 300 and so on, and the second factor may correspond to a factor input to the second output function as an input value specified through a user's setting.

In an example of the present disclosure, the second factor may be designated by the selection of a user input via the user interface screen, for example, a second factor regarding a rendering position of the corresponding display element may be input via a selection button (e.g., right, left, and center), or an input window, or a second factor regarding a rendering position of the corresponding display element may be input according to an event of click and drag and drop on the corresponding display element, and the second output function regarding the corresponding display element may render the corresponding display element from the second factor to the position set by the user.

For example, a second factor may be input by the selection input of a menu regarding the location, size, color, and font side to determine the rendering design of the selected display element as a plurality of detailed items that are deployed to the lower menu accompanying the selection of the currently selected display element among the plurality of display elements through the user interface screen, and the second output function regarding the corresponding display element may render the corresponding display element according to the position, size, color, font size, etc. set by the user from the second factor.

In an example of the present disclosure, the first and second factors may correspond to variables stored in a local memory area during the operation of the user interface screen for user setting or during the operation of an application loaded on the user terminal 100 through a document or file obtained from the processing server 200 to drive the user interface screen. After the end of the user interface screen or the application driving the user interface screen, the first factor is a variable for storing real-time status data, and for example, may be replaced with another appropriate variable for an Application Programming Interface (API) with the operating system 301 of the smartwatch 300 and so on, which is searched from the user information stored in association with the corresponding user ID (converted to an appropriate code capable of communicating with the operating system 301 of the smartwatch 300), and the second factor may be constantized to maintain the user setting regarding the rendering details as it is. In an example of the present disclosure, the constantization of the second factor in which the user setting regarding the rendering details is stored may refer to that it is maintained as or replaced with a variable or constant that is not affected/interrupted by the operating system 301 of the smartwatch 300 or all kinds of applications running on the operating system 301.

In an example of the present disclosure, the user interface screen or an application that drives the user interface screen may transmit a code for creating the customized watch face to the processing server 200 according to a request of the user after the user's final selection, e.g., according to a click event of an apply button on the user interface screen, and the processing server 200 stores the code for creating the watch face that finally reflects the user settings in the database 400 in association with the user's ID. Meanwhile, the code for creating the watch face may be loaded onto the smartwatch 300 associated with the user's ID so that the watch face can be generated through an application running on the smartwatch 300. In this case, the processing server 200 may convert the first factor into a variable suitable for storing status data obtained from the operating system 301, according to the operating system 301 of the watch face associated with the ID of each user (converted to a suitable code capable of communicating with the operating system 301 of the smartwatch 300). For example, for the operating system 301 of the smartwatch 300 and the API with the code for creating the watch face or an application related to creating the watch face, the first factor may be converted into a variable suitable for storing the status data input from the operating system 301 of the smartwatch 300 and so on. In addition, unlike the first factor that requires communication with the operating system 301 to store status data obtained from the operating system 301 of the smartwatch 300 and so on, the processing server 200 may constantize the second factor in which the user setting is stored so that the user setting stored in the second factor is not changed. For example, the value of the second factor may be constantized so that the value of the second factor in which the user settings for the detailed design of the rendering, such as the position, size, font size, color, etc., of the corresponding display elements, are stored is not changed by communication with the operating system 301 or other applications, and after the code for creating the watch face is loaded on the smartwatch 300, the user setting of the watch face implemented on the smartwatch 300 may not be changed until the user's reset.

In another aspect of the present disclosure, among the first and second factors that are input to the first and second output functions for rendering of display elements, respectively, the second factor which at least does not need to obtain and store status data from the operating system 301 of the smartwatch 300 and in which the user settings are stored and the user settings need to be maintained may be stored in a local memory area only during the operation of the user interface screen or the application driving the user interface screen on the user terminal 100, and may be constantized by the processing server 200 or the application driving the user interface screen after the user interface screen or the application driving the user interface screen is terminated, and the first factor which needs to be stored by receiving status data from the operating system 301 of the smartwatch 300 and so on may be converted into a suitable variable capable of communicating with the operating system 301 of the smartwatch 300 to which the watch face reflecting the user setting is applied or may maintain the value of the first factor capable of communicating with the operating system 301 via the processing server 200 or the application driving the user interface screen.

In an example of the present disclosure, the watch face may be formed by overlapping a plurality of sub-layers overlapping each other. For example, according to an example of the present disclosure, different display elements forming the watch face may be rendered on different sub-layers aligned with respect to the origin of the image coordinate system (pixel position forming the origin point) set on the screen of the watch face. For example, in an example of the present disclosure, each of all display elements that form a watch face may be rendered on different sub-layers to form one watch face by overlapping each other along the z-direction (the depth direction of the watch face), and other backgrounds except for the area where the image of the display element is output among the upper sub-layers are transparently processed for the lower sub-layer, so that, for example, the display element of the lower sub-layer could be visually output through the background of the upper sub-layer.

In various examples of the present disclosure, at least two of the display elements that from a watch face may be rendered on different first and second sub-layers along the z-direction (the depth direction of the watch face), and different display elements set on the first and second sub-layers may overlap each other along the z-direction to form one watch face. For example, in an example of the present disclosure, the watch face may be displayed as the highest sub-layer or as the lowest sub-layer, such as the background, according to an overlapping order given by different z-indexes along the z direction corresponding to the direction in which different sub-layers overlap each other. For example, in an example of the present disclosure, a z-index corresponding to a relatively higher sub-layer may be assigned to a display element assigned to a type of information corresponding to status data related to weather, time, health, exercise, and remaining battery capacity, and a z-index corresponding to a relatively lower sub-layer may be assigned to a display element assigned to a type of information corresponding to decorative design data (e.g., background of a watch face). In an example of the present disclosure, a display element assigned to a type of information corresponding to real-time status data may be rendered on an upper sub-layer, and a display element assigned to a type of information corresponding to decorative design data (e.g., background of a watch face) may be rendered on a lower sub-layer. For example, in an example of the present disclosure, the watch face may include two sub-layers overlapping each other along the z-direction, and for example, may include a higher sub-layer in which a display element assigned to a type of information corresponding to real-time status data is rendered and a lower sub-layer in which a display element assigned to a decorative design data (e.g., background of a watch face) is rendered. In an example of the present disclosure, the display element assigned to the type of information corresponding to real-time status data may be generated from a first output function that calculates an output value (parameter) for rendering the display element reflecting the status data, using real-time status data as the first factor, and the display element assigned to the decorative design data may be generated from a second output function that outputs the display element assigned via user settings, reflecting the user settings regarding the rendering detailed design, such as location, and for example, the rendering of the display element assigned according to the user settings may be output from the second output function using the user settings regarding the rendering detailed design as the second factor. For example, the second output function may render image data about the assigned display element or image data obtained from an access path of the image data according to the second factor input via the user settings, and may render the image data to a location coordinates according to the user settings stored as the second factor.

In various examples of the present disclosure, a plurality of display elements that form a watch face may be rendered on different sub-layers, and for example, each display element that forms a watch face may be given a different z-index to be rendered on different sub-layers. Accordingly, each of a plurality of display elements may be distinguished from each other using a z-index, and may be recognized or specified by different z-indexes. In this case, the remaining area, excluding the location where the display element is rendered among the upper sub-layers, is processed transparently to the lower sub-layer so that the lower sub-layer may be displayed to the sub-layer. In various examples of the present disclosure, the display elements rendered to the upper sub-layer and the display elements rendered to the lower sub-layer may overlap each other and give different visual design effects, and for example, the display elements assigned to the status data of the current time may be rendered relatively large to the lower sub-layer, overlapping with other types of information displayed on the upper sub-layer while visually expressing information about the current time. In this way, in an example where different display elements are given different z-indexes so that they are rendered on different sub-layers, each display element may be recognized through a z-index, and for example, the output function assigned to each display element that forms a watch face may be given on a sub-layer basis, and may be recognized or identified on each sub-layer basis.

In an example of the present disclosure, via a communication between the processing server 200 and the user terminal 100, a user interface screen displaying a plurality of menu items may be implemented on the user terminal 100, and user settings for selections regarding the type of information to be rendered on a watch face and user settings for standardized display elements to be assigned to the selected type of information may be performed. Here, the standardized display element is a display element obtained from the processing server 200 or the database 400 connected to the processing server 200 and implemented on the user interface screen, and may refer to, for example, a display element produced in advance from the processing server 200 and formed in several standardized forms of database, and in an example of the present disclosure, it may be used as a concept in contrast to digital content stored in the local area and incorporated into a new display element according to a user's selection to form a unique watch face by applying data stored in the user's own local area via the user interface screen. In an example of the present disclosure, the local area may refer to a front-end (service request) in contrast to the processing server 200 of a back-end (service provision). For example, in an example of the present disclosure, the digital content incorporated into the display element of a watch face is not limited to data stored in the local area of the user terminal, but may comprehensively refer to, for example, digital content that can be obtained through a cloud service that can be accessed via a communication network from the user terminal without passing through the user terminal.

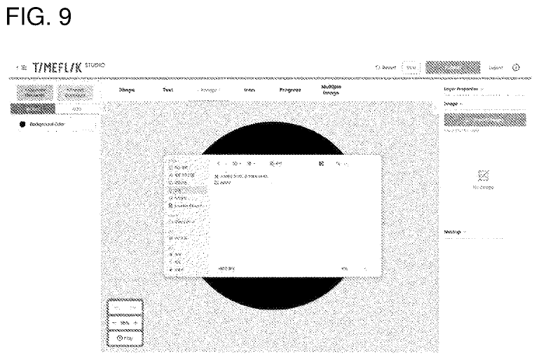

FIG. 9 illustrates a diagram showing an example of a user interface screen for loading digital contents stored in the local area.

Referring to the drawing, according to an example of the present disclosure, digital content, which is incorporated into a new display element according to a user's selection or preference, may be incorporated into a new display element from the local area through a menu, such as a search, provided on the user interface screen and rendered as part of the watch face on the user interface screen, and digital content stored in the local area and incorporated into a new display element according to a user's selection may form different display elements assigned to different types of information.

According to an example of the present disclosure, a display element that forms a watch face may include a display element assigned to a first-type information corresponding to real-time status data, and a display element assigned to a second-type information corresponding to decorative design data. Digital content incorporated into a new display element at a user's selection may be limited to a second-type information corresponding to decorative design data, for example, a second-type information corresponding to decorative design data, such as background of the watch face, and may not be assigned to the first-type information corresponding to real-time status data. For example, according to an example of the present disclosure, the digital content may correspond to a new display element loaded from the local area and implemented on the watch face according to the user's preference or taste. Such digital content is more likely to take the form of image data preferred by the user rather than taking the form of an output function for rendering real-time status data, and creates a watch face via a set of a plurality of output functions for rendering different display elements obtained through the processing server 200. For a set of a plurality of output functions that exclude the possibility of interference with each other (a set of output functions previously created to exclude the possibility of interference with each other from the processing server 200 side), the incorporation into a new display element may be limited for any output function stored in the local area at the user's selection and stored in the local area despite the user's selection to prevent damage to the rendering of the watch face due to the intervention of the randomly loaded output function.

According to an example of the present disclosure, as digital content that may be incorporated into a new display element from the local area according to a user's selection, there is no need to limit image data without the possibility of interference with the output function for the generation of other display elements. For the second-type information, such as a background in which the user's preference or taste for the decorative part of the watch face may be reflected in a relatively large percentage while the decorative effect provided by the watch face is large, digital content (image data) may be loaded onto a watch face provided on the user interface screen and incorporated into a new display element.

In this way, according to an example of the present disclosure, the user's digital content may be loaded and incorporated into a new display element by reflecting the user's preference or taste, and digital content as a new display element may be combined with each other to form a watch face. For example, the user's digital content (image data) may be rendered on the lowest sub-layer to form the background of the watch face. For example, a user interface screen or an application that drives a user interface screen implemented on the user's terminal via the processing server 200 or a document or file obtained from the processing server 200 allows loading of image data according to the type of digital content selected by the user, but may limit loading of executable data including an output function, for example. For example, according to the example of the present disclosure in which the processing of replies to a series of user's selection or requests made on a user interface screen is returned via the user terminal 100 or application that runs on the user terminal 100 following the policy of the processing server 200 and is installed via the computation of the processing server 200 associated with the user terminal 100 or a document or file transmitted from the processing server 200, the processing server 200 may limit loading of digital content such as an output function excluding digital content such as image data despite the user's selection. However, according to an example of the present disclosure, unlike the loading of digital content to be incorporated as new display elements forming a watch face, editing of a watch face stored in the database 400 to form a new watch face, i.e., editing of a watch face, may not be limited to the loading of digital content. Here, editing a watch may refer to deleting at least one display element from a plurality of display elements forming the watch face, or adding a display element that is different from a display element forming an existing watch face.

In an example of the present disclosure, after the user settings is completed via the user interface screen, a code for creating a watch face reflecting the user settings may be transmitted from the user terminal 100 to the processing sever 200 according to a request of the user, for example, according to a click event of the user's Apply button, and stored in the database 400 associated with the processing server 200 and also stored in the database 400 associated with the user's ID. In this case, the processing server 200 may perform image processing on a new display element loaded from the user's digital content and incorporated into the watch face. For display elements that may conflict with well-known brands via image processing (possibility of being mistaken or confused with well-known brands), a warning message may be sent via the user terminal 100 indicating that the corresponding digital content cannot be applied to the watch face, despite the user's attempt to load it. For example, a smartwatch 300 where a watch face can be applied can be recognized as an accessory as a small fashion item such as a watch and as a fashion item that can express social positioning, so as a user, it is likely to attempt to render on his or her watch face by converting a well-known brand into a display element. The processing server 200 may send a warning to the user by determining whether there is a possibility of conflict (misunderstanding/confusion) with a well-known brand via image processing of a display element incorporated from digital content so that it blocks the user's attempt to make a well-known brand into a display element, and instead of the currently selected digital content, it may request a selection of a new digital content.

According to an example of the present disclosure, the watch face may be rendered on different sub-layers with different z-indexes along the z direction (the depth direction of the watch face), and via image processing for sub-layers to which digital content is applied, for example, the lowest sub-layer that forms the background of the watch face, a display element with the possibility of conflict with the well-known brand (possibility of being mistaken or confused with well-known brands) may be identified so that no well-known brand or similar brand is displayed on the background of the watch face.

According to an example of the present disclosure, the processing server 200 may include a web server 201 that receives a request from the user terminal 100 and transmits a reply using a web document, such as HTML, and a module (e.g., a servlet) that is connected to the web server 201 to perform each designated process. The processing server 200 may include an image processing module 240 for calculating the possibility or similarity of conflict with a well-known brand. For example, the processing server 200 may operate an image processing module 240 connected to the processing server 200 and perform image processing on a sub-layer to which digital content is applied. The image processing module 240 may include an Artificial Intelligence (AI) network containing learned weights using visual images (such as characters or logos) of well-known brands as training data. For example, may calculate similarities with well-known brands for sub-layers (display elements rendered on sub-layers) input through a Convolution Neural Network (CNN) network suitable for image processing. The processing server 200 may determine whether to allow digital content incorporated into the display element by comparing it with a pre-set criterion value according to the similarity output from the image processing module 240.

In various examples of the present disclosure, for characters or images that violate public order and morality, which can damage the image of a service provider providing the user interface, the processing server 200 may extract the possibility of violating public order and morality through an AI network or CNN network suitable for image processing, similar to the method of extracting the possibility of misunderstanding/confusion with well-known brands described above. Depending on the existence of digital content incorporated into a display element, for example, the processing server 200, which detects a click event on a menu of searches for digital content on the user interface screen, may operate the image processing module 240 by inputting a corresponding digital content from a series of codes for creating the watch face transmitted from the user terminal 100 (e.g., digital content rendered on sub-layer with the lowest z-index), may not allow the corresponding digital content depending on an output value of the possibility of violating public order and morality (similarity to characters or images contrary to public order and morality) output from the image processing module 240, and may request the selection of new digital content via the user terminal 100.

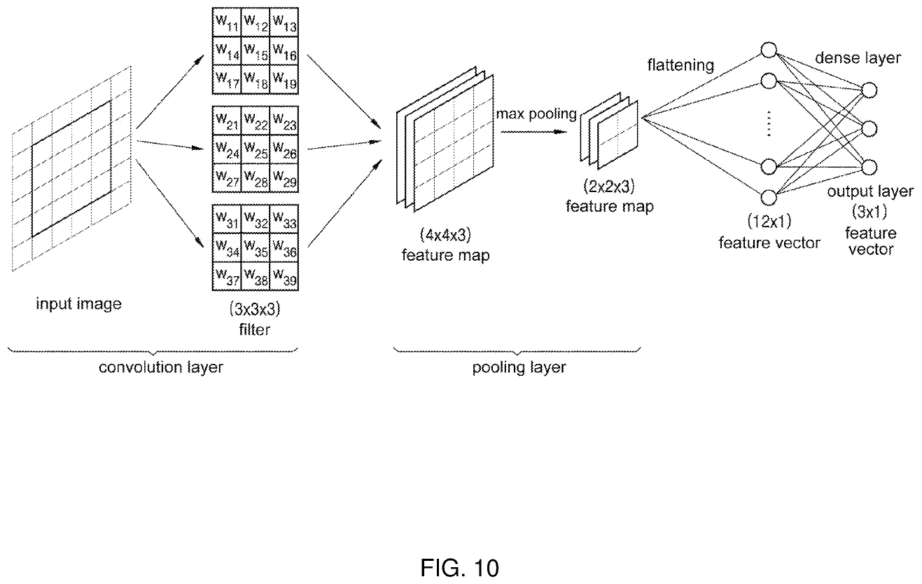

FIG. 10 illustrates a schematic diagram showing a CNN network that is applicable in an image processing module 240 and a similarity calculation module 260 as part of the configuration of a processing server 200 according to an example of the present disclosure.

Referring to the drawing, the image processing module 240 is an AI network, which may include a CNN network that includes a weight (filter or kernel) learned from a well-known brand image or a visual image that violates public order and morality as training data. For example, the CNN network takes digital content as input image, and may include a convolution layer containing a plurality of filters (or kernels, weights) and a pooling layer (max pooling or average pooling) to reduce the size of the feature maps calculated from the convolution layer, and ultimately may output a predicted probability regarding the possibility of a conflict with well-known brand for the input digital content or a possibility of a violation of public order and morality by using flattening that transforms a 3-dimensional feature map with matrix-shaped 2-dimensional and depth dimensions into a 1-dimensional form and a dense layer covering an output layer that is completely connected to the flattered 1-dimensional feature vector. Meanwhile, the CNN network, as mentioned above, may be applied not only to the image processing module 240 but also, as described later, to a similarity calculation module 260 that calculates the similarity between pre-edited watch face and post-edited watch face to determine the contribution of a pre-edited watch face to a post-edited watch face. In the similarity calculation module 260, each pre-edited watch face and post-edited watch face are taken as inputs, feature vectors are generated from each pre-edited watch face and post-edited watch faces, and the similarity (Euclidean distance or cosine similarity) between the generated feature vectors is calculated. In this way, the similarity between pre-edited watch face and post-edited watch face may be outputted.

After the user's selection is completed via the user interface screen, according to a request of the user, for example, a click event of Apply button provided on the user interface screen, an application driving the user interface screen may transmit a code for creating a watch face reflecting the user settings from the user terminal 100 to the processing server 200 via the communication with the processing server 200. The processing server 200 that obtained the code for creating a watch face from the user terminal 100 may determine the possibility of conflict with a well-known brand and the possibility of violating public order and morality for digital content incorporated into a display element on the watch face, depending on the history of the user settings, for example, whether a click event for the menu of search (loading digital content) occurs on the user interface screen. The processing server 200 may perform a process for converting the obtained code for creating a watch face into a suitable converted code capable of communicating with the operating system 301 of the user's smartwatch 300 according to the operating system 301 of the user's smartwatch 300 stored in association with a user's ID to which the code for creating a watch face is given, e.g., for APIs with Android or Apple IOS.

According to an example of the present disclosure, the processing server 200 may include a web server 201 that receives a request from the user terminal 100 and sends a reply using a web document such as HTML, and a module (i.e., servlet) connected to the web server 201 to perform each designated process, and the processing server may further include a converting module 250 in addition to the image processing module 240 described above. For example, according to an example of the present disclosure, for API with the corresponding operating system 301, the converting module 250 may perform a process of converting the code for creating a watch face reflecting user settings into a suitable converted code. The processing server 200 may store the converted code for creating a watch face in a database 400 associated to the processing server 200, search for user information related to the user's ID, and transmit it to the searched smartwatch 300.

According to an example of the present disclosure, the processing server 200 may store information about the user's smartwatch 300, information about the user's watch face, along with the user's ID, as information of a user subscribed to the processing server 200, and may store identification number (unique number) of the watch face that is associated with the user's ID and stored in the database 400, as information of the user. For example, the processing server 200 may allow editing of the existing watch face according to the user's request through the user interface screen, output the watch face stored in the database 400 on the user interface screen to edit the watch face, and edit, such as deletion or addition, a display element that forms the existing watch face to create a new watch face. Like the existing watch face, a watch face newly created editing existing watch faces may be transmitted to the processing server 200 through a click event of Apply button on the user interface screen and stored in the database 400, may be stored in the database 400 with another identification number, along with the existing watch face, and may be stored in association with the user's ID. As a series of watch face lists that can be edited in response to a user's edit request via the user interface screen (e.g., the Browse menu), a watch face newly created by editing the existing watch faces may be output on the user interface screen along with the existing watch faces.

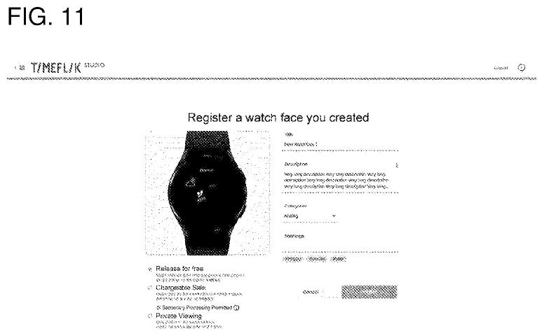

FIG. 11 illustrates a diagram of showing an example of a user interface screen displaying completed user settings for a watch face and showing a phase where a user interface for NFT registration or minting is provided based on the user's choice.

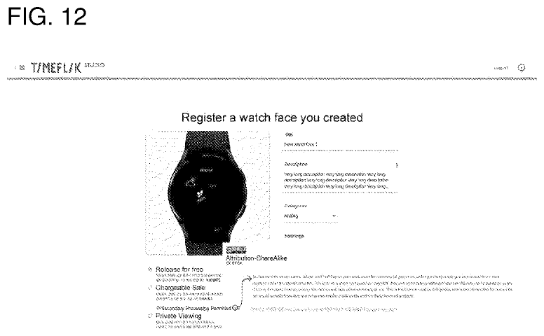

FIG. 12 illustrates a diagram showing an example of a user interface screen displaying completed user settings for a watch face and showing a menu related to the user's choice regarding permission for secondary processing or editing.

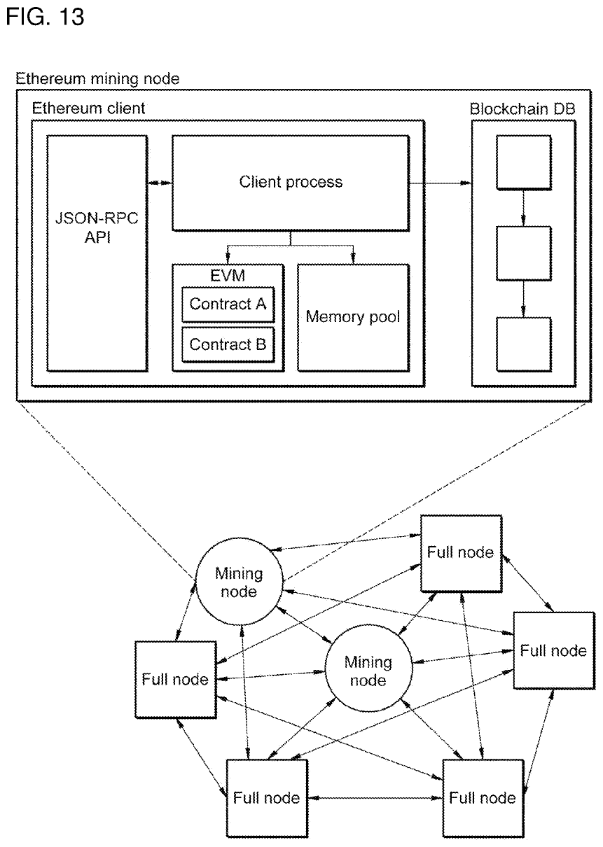

FIG. 13 illustrates a block diagram showing a schematic configuration of the Ethereum network and a node constituting the Ethereum network, i.e., a mining node or full node.

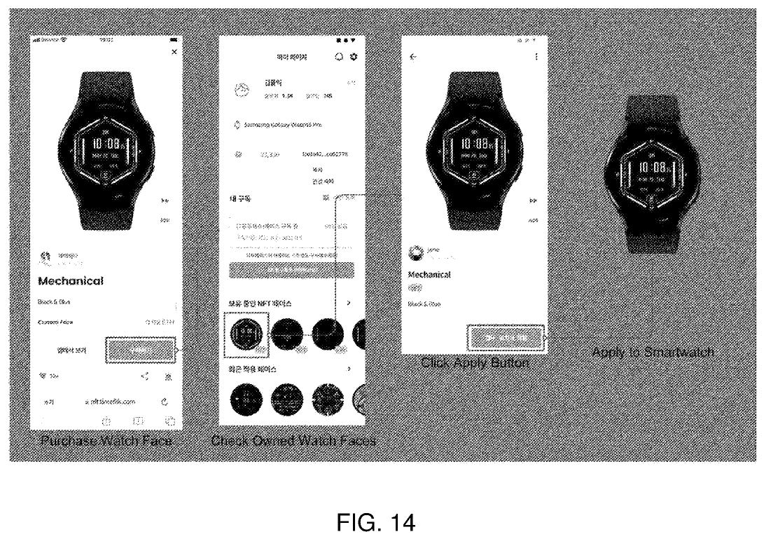

FIG. 14 illustrates a diagram showing an example of a series of processes, through a web page managed by a processing server 200, of registering a watch face as a product, completing the sale based on a buyer's selection, listing and displaying a group of watch faces owned by the buyer, and applying a watch face selected by the user to a smartwatch 300.

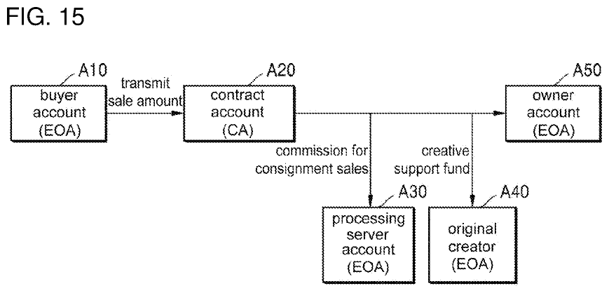

FIG. 15 illustrates a schematic diagram showing the process where a portion of the sales revenue transferred from a buyer account A10 to a contract account A20 is distributed to a processing server account A30 and an original creator account A40 as respective commission fees and creation support funds in accordance with the terms of the contract.

Referring to the drawings, the processing server 200 may allow Non Fungible Token (NFT) registration or minting of a watch face created by a user himself/herself via the user interface screen, and may provide a user interface for NFT registration or minting. For example, after the final user setting is completed, the processing server 200 may provide a selection menu on whether to register an NFT before or after a user's request for applying a watch face reflecting the user settings (a click event of Apply button on the user interface screen), and may proceed with the NFT registration process that follows the user's click event of the NFT registration button. For NFT registration, the user's convenience for NFT registration may be increased in that creation of a watch face is allowed via a series of user interface screens provided from the identical processing server 200 and NFT registration is allowed via a continuous process without having to go through the cumbersome task of accessing the blockchain network and installing a separate program, such as Geth to build nodes on Ethereum-based blockchain networks.

For example, the processing server 200 may access a Bitcoin or Ethereum-based blockchain network according to a request of a user for NFT registration and perform so-called NFT minting, which stores, on the blockchain, NFT registration information, such as creator information of a watch face and storage location of a watch face, as digital content to be registered on the blockchain. Since the processing server 200 stores a code for creating a watch face reflecting the user setting in the database 400 associated with the processing server 200, the storage location of a watch face as NFT registration information may include information on an access address that can be connected to the processing server 200. In addition, the processing server 200 may search for the information of the user who requested NFT registration in order to extract a creator's information as NFT registration information from the database 400.

In an example of the present disclosure, information of a creator stored on the blockchain in connection with NFT registration may refer to the information of a user who created a watch face to be registered as an NFT, and may include information about a user who created a new watch face by selecting a standardized display element provided from the processing server 200, information about a user who created a new watch face, including digital content loaded from the user's local area, along with the standardized display element provided through the processing server 200, and information about a user who created a new watch face by editing. For example, according to an example of the present disclosure, even a user who created a watch face by editing may be registered as an NFT creator on the blockchain as a creator of a watch face newly created by editing. However, according to an example of the present disclosure, regarding a watch face newly created by editing, depending on the contribution ratio of a pre-edited watch face to a post-edited watch face (similarity of the pre-edited watch face and post-edited watch face described later), an original creator who initially created the pre-edited watch face may receive a portion of the economic benefits generated from the post-edited watch face, e.g., a portion of the sales revenue of the post-edited watch face in NFT registered, may be paid to an original creator who created a pre-edited watch face as a creation support. According to an example of the present disclosure, an original creator eligible for a creation support may refer to a user who originally created a corresponding watch face, and may be a different user than the creator of the NFT registration information for the post-edited watch face (i.e., a user who created a new watch face by editing).

In an example of the present disclosure, the processing server 200 may store editing history information of the watch face in a database 400 connected to the processing server 200 in connection with each watch face. In connection with a watch face created by editing, the processing server 200 may store user information of a series of watch faces newly created by editing, as well as information of a user who created a watch face newly created by editing, and information of a user who originally created a pre-edited watch face, in an orderly manner. The corresponding editing history information may include data on whether a corresponding watch face is registered as an NFT.

For example, the processing server 200 may recognize a user who creates a new watch face by editing a pre-edited watch face (post-edited watch face) and stores it in the database 400 as the creator of the NFT registration information, and may recognize a user who first created the corresponding watch face by looking up the editing history information stored in association with the pre-edited watch face as the original creator to whom the revenue for the post-edited watch face is allocated (i.e., a portion of the sales revenue of a post-edited watch face is paid in the form of a creation support fund according to the contribution ratio (similarity of the pre-edited watch face and the post-edited watch face) as described later. In other words, the processing server 200 may recognize a user who creates a post-edited watch face and stores it in the database 400 connected to the processing server 200 as a creator of NFT registration information, or, alternatively, the processing server 200 may look up the editing history information of the corresponding watch face and recognize a user who first created the pre-edited watch face as the original creator to whom the revenue for the post-edited watch face is distributed.

In an example of the present disclosure, the processing server 200 may perform NFT minting to store NFT registration information on a database 400 of a blockchain that includes a database 400 of each full node and mining node connected in a peer-to-peer manner. For example, in a Bitcoin-based blockchain, NFT registration information may be stored on the database 400 of the blockchain in the form of a transaction, and in the Ethereum-based blockchain, NFT registration information may be stored on the database 400 of the blockchain in the form of a smart contract. The processing server 200 may create a smart contract containing NFT registration information and deploy it on an Ethereum-based blockchain. For example, the smart contract may be written in Solidity and converted into Ethereum Virtual Machine (EVM) bytecode, which is executable by the EVM of a mining node. For example, a smart contract created from the processing server 200 may be propagated or deployed from an adjacent peer node, and a mining node that obtains a smart contract from an adjacent peer node may store the smart contract in a memory pool and convert it into executable EVM bytecode for execution by using the EVM. The smart contract stored in the memory pool may be linked to the chain of a previously generated block and hash values through mining, which corresponds to the computational operation of the hash function to find a suitable hash value, and may be created as a new block that includes a suitable hash value in a block header, and connected to the previous block by a chain of hash values, preventing forgery of the smart contract stored in the block. For example, an account on a blockchain based on Ethereum may include an Externally Owned Account (EOA) and a Contract Account A20 (CA), and unlike an EOA, such as a digital wallet, the contract account A20 may have a deployed smart contract (a smart contract converted to EVM bytecode) and storage space, and the smart contract may be activated through a call by the EOA as an autonomous agent (e.g., a remittance from an EOA owned by a buyer of a watch face registered as an NFT in the future).

In this way, the processing server 200 may provide an interface for NFT minting and offer an online marketplace for registered NFT. For example, according to a request of an NFT owner (a user who has requested registration for a watch face he or she has created), the processing server 200 may register the NFT as a watch face product on a web page managed by the processing server 200, may expose the registered watch face product to visitors of the web page, and may indicate the corresponding watch face product as an NFT-registered watch face on the product description or appearance.

The processing server 200 may incorporate into the contract terms of the smart contract for NFT minting the allocation of a certain portion of the sales proceeds of the registered watch faces as a consignment sales commission for the processing server 200 (a service provider managing processing server 200). Consequently, as a purchaser of registered NFT watch face, a user may transfer the sales revenues to the contract account A20 on the blockchain. The smart contract then automatically divides the sales revenues among the NFT owner (a user who registered his or her created watch face as an NFT and requested consignment sales through processing server 200) and the processing server 200 (a service provider managing the processing server 200), referring to the specific details of the consignment sales commission incorporated into the contract terms. The divided amounts are then sent to each respective owner account A50 and processing server account A30. Here, the owner account A50 and processing server account A30 may correspond to EOA (digital wallet) respectively.

In an example of the present disclosure, an NFT owner may expose his/her watch face product to a plurality of web page visitors through a web page managed by the processing server 200, while securing reliability related to their profits, excluding consignment sales fees from consignment sales fees or sales payments that accompany consignment sales through smart contracts that automatically execute contract details through calls. In addition, as a processing server 200 (a service provider that manages the processing server 200) may reduce the additional work burden related to sales fees and ensure the execution of reliable contracts. For example, disputes or additional tasks related to consignment sales fees may be mitigated, for example, by transferring the sales revenue directly to a seller, that is, the user of the NFT registered watch face, to a contract account A20 of the smart contract that automatically executes the contract.

In an example of the present disclosure, a user who purchased an NFT-registered watch face through a web page managed by the processing server 200 may create a new watch face (a post-edited watch face) that reflects his or her taste or preference by editing of the watch face (a pre-edited watch face) provided by the same processing server 200, and may also perform so-called NFT minting to register on the blockchain by accessing the blockchain network through the processing server 200. In this case, the processing server 200 may promote the creation of customized watch face and expand the market of customized watch face created by non-experts by allocating a certain portion of the sales revenue to an original creator who created the watch face for the first time before editing as a consignment sales fee of the processing server 200. In accordance with this purpose, according to an example of the present disclosure, the processing server 200 looks up the editing history information stored in association with the corresponding watch face, and determines from the query result of the editing history information that the corresponding watch face has a plurality of edit histories. Even if the processing server 200 confirms that the corresponding watch face has a plurality of editing histories and that the corresponding watch face was created by editing by a plurality of users, the processing server 200 may only allocate the creation support fund to a user who first created the corresponding watch face, i.e., the original creator, and may not allocate the creation support fund to other users after the original creator. For example, the processing server 200 may not allocate creation support fund to users after the first original creator who created a watch face, such as a user who created a new watch face by editing after the first original creator, or a user who purchased a watch face created either from the first original creator or by editing by a user after the original creator and then resold it without making and edits to the watch face.

In an example of the present disclosure, in response to a user's request via the user interface screen (a click event for loading the watch face to be edited), the processing server 200 may output the watch face stored in the database 400 associated with the user's ID on the user interface screen and allow the user to edit the watch face. Furthermore, the processing server 200 may obtain a code for creating a watch face of the user where the editing has been completed vis the user terminal 100. In this case, the processing server 200 may recognize that the obtained code corresponds to a watch face edited (the post-edited watch face) from a pre-edited watch face by referring to a history of user settings, e.g., a history of edit requests via a user interface screen and may determine whether the NFT is registered for the corresponding watch face from the editing history information stored in association with the pre-edited watch face. In this way, the processing server 200 may check whether the corresponding watch face has been edited by looking up the history of user settings, and whether NFT has been registered for the pre-edited watch face by looking up the editing history information of the pre-edited watch face. The processing server 200 may calculate the similarity between the pre-edited watch face and the post-edited watch face based on the results of looking up the history of the user settings and the editing history information, and may incorporate the creation support fund to the original creator who first created the pre-edited watch face in the smart contract for NFT registration or mining into the contract content of the smart contract when promoting NFT registration for the post-edited watch face in the future, and may determine the proportion of the creation support fund to the original creator, e.g., the proportion of the creation support fund to the sales revenues, based on the similarity between the pre-edited and post-edited watch faces. In this case, the processing server 200 may calculate a similarity between the post-edited watch face and the pre-edited watch face, with the pre-edited watch face being the first created watch face in the editing history information, and may recognize the similarity as a contribution ratio of the pre-edited watch face to the post-edited watch face, and allocate a creation support fund corresponding to the contribution ratio or similarity.

In other words, if NFT registration or minting is promoted for a watch face after editing and sales are made to the watch face registered with NFTs, a portion of the sales revenue for the NFT-registered watch face may be distributed as a creation support fund to the original creator who created the first watch face before editing based on contract details of the smart contract created and distributed by the processing server 200 for NFT registration. In this case, the distribution ratio of the sales revenue between the pre-edited watch face and the post-edited watch face may be calculated by the processing server 200 based on the similarity between the pre-edited watch face and the post-edited watch face.

The processing server 200 may receive a loading request for a pre-edited watch face, look up whether an NFT is registered for the watch face, and transmit a watch face (a pre-edited watch face) to the user terminal 100. At this time, in various examples of the present disclosure, the processing server 200 may output a notification message on the user interface screen according to the result of inquiring whether to register an NFT, and more specifically, the processing server 200 may send a notification message notifying that a portion of the sales revenue may be paid as a creation support fund if NFT registration and sales are promoted in the future since the watch face loaded on the user interface for editing (a pre-edited watch face) is an NFT registered watch face. The processing server 200, which obtained the watch face reflecting the user setting from the user terminal 100 (a post-edited watch face), may operate a similarity calculation module 260 connected to the processing server 200 using the pre-edited watch face and the post-edited watch face as two inputs to calculate the similarity between the pre-edited watch face and the post-edited watch face.

In an example of the present disclosure, the processing server 200 may include a web server 200 that accepts a request from the user terminal 100 and transmits a response using a web document, such as HTML, and a module (e.g., a servlet) connected to the web server 201 to perform each designated process, and the processing server 200 may further include a similarity calculation module 260, in addition to the image processing module 240 and the converting module 250 discussed above.

In an example of the present disclosure, the similarity calculation module 260 may calculate a similarity between visual images of a pre-edited watch face and a post-edited watch face. For example, a code for creating the watch face may include an output function that renders a display element to reflect real-time information using status data updated with real-time information as a factor. For example, unlike decorative design data, such as background of the watch face, since the output function does not contain image data, the similarity between the pre-edited watch face and post-edited watch face may be calculated from a visual image of the watch face output from the code for creating a watch face, rather than comparing the code itself. For example, the similarity calculation module 260 may input visual image or image data output inputting real-time status data to the code for creating pre-edited and post-edited watch faces to an artificial intelligence (AI) network, such as a CNN network, suitable for image processing, to calculate a feature vector that extracts high-dimensional characteristics of the video images of the pre-edited watch face and the post-edited watch face, respectively, using the feature vectors extracted from the visual images of the pre-edited watch face and the post-edited watch face, and may numerically calculate the similarity between the pre-edited watch face and the post-edited watch face based on, for example, Euclidean distance or cosine similarity, by using a feature vector extracted from the visual image of the pre-edited and post-edited watch faces. In this way, by the similarity calculation module 260 numerically calculating the similarity, a distribution ratio of the sales price between an original creator who created the first watch face before editing and an editor who created a post-edited watch face may be calculated based on the similarity of the visual images before and after the editing. For example, according to an example of the present disclosure, the similarity calculation module 260 may input the same real-time status data for the entire code including the set of output functions for creating the watch face and image data or an access path of the image data to compare the visual image to compare the visual image or image data returned as the output of the code with each other before and after editing. The code for creating the watch face may include an output function for rendering a display element that forms the watch face by reflecting real-time status data, and image data for rendering decorative design data, such as the background of the watch face. In this case, the visual image that is subject to similarity calculation before and after editing is an image that is a combination of all display elements that form the watch face, i.e., display elements that are rendered reflecting real-time status data and display elements that are rendered regardless of real-time status data, and the similarity between pre-edited and post-edited watch faces may be calculated based on the visual image.

In an example of the present disclosure, the processing server 200 may operate the similarity calculation module 260 to calculate the distribution ratio regarding the allocation of creation support fund divided between the original creator of a pre-edited watch face and the user of a post-edited watch face. For example, when NFT registration is executed for the post-edited watch face and NFT registered watch face is sold, the processing server 200 may operate the similarity calculation module 260 to determine the creation support fund distributed to creators among the sales revenue and may register the post-edited watch face and delay the time when the NFT registered watch face is sold. For example, until the sales revenue for the NFT registered post-edited watch face is transferred to a contract account of the smart contract, the processing server 200 may operate the similarity calculation module 260 to calculate a similarity between the pre-edited and post-edited watch faces or a distribution ratio of creation support fund based on the similarity.

In an example of the present disclosure, the processing server 200 may call a smart contract (or contract account A20) according to the similarity output from the similarity calculation module 260 or the distribution ratio calculated based on the similarity. For example, the processing server 200 may call a function on the distribution amount of creation support fund incorporated into the contract details of the smart contract, and have the smart contract output a specific distribution amount using the calculated smart distribution ratio as a factor, and according to the output distribution amount, the smart contract may divide the sales revenue transferred to its own contract account A20 into shares for the original creator and owner, respectively, and subsequently remit these portions to the respective original creator account A40 and owner account A50.

In an example of the present disclosure, the processing server 200 may determine the similarity between the pre-edited and post-edited watch faces or the calculation timing of calculating the distribution ratio of the creation support fund based on the similarity as any point in the time period from when the user setting via the user interface screen is completed and the post-edited watch face is transmitted to the processing server 200, through the NFT registration of the post-edited watch face, up to moment before the sales revenue of the post-edited watch face is transferred. For example, the timing of calculating the distribution ratio of the creation support fund may be delayed to an appropriate time in consideration of the computational burden of the processing server 200, and since delaying the calculation of the distribution ratio for creation support fund until just before transferring the sales revenue of the post-edited watch face, which is substantially required, may help prevent unnecessary waste of computational resources for the processing server 200, the timing of calculating the creation support fund may be delayed as much as possible for efficient resource allocation. Meanwhile, the contents related to the creation support fund may be incorporated into the contract details of the smart contract for NFT registration of a post-edited watch face, and in the smart contract for NFT registration of a post-edited watch face, rather than specifying a specific distribution ratio for creation support fund, a division between the original creator and owner may be made by calling a smart contract that includes a function that calculates a specific distribution amount using the distribution ration calculated operating the similarity calculation module 260 later as a factor and delivering a distribution ratio. For example, by transferring the sales revenue of a post-edited watch face to a contract account A20 of the smart contract and delivering the distribution ratio of creation support fund calculated through the operation of the similarity calculation module 260 to the contract account A20, a distribution amount allocated to respective original creator and owner may be calculated via a function incorporated into the contract details of the smart contract.

In an example of the present disclosure, regarding the allocation of the creation support fund, as an original creator to which the sales revenue for the post-edited watch face is allocated, the processing server 200 may limit, for example, an original creator who created first a pre-edited watch face and also an original creator who registered the first created watch face as an NFT, and for example, in line with the purpose of promoting the creation of customized watch faces and expanding the market for customized watch faces created by non-professionals, even if not registered as an NFT, the creation support fund may be allocated to an original creator who first created the pre-edited watch face, and the processing server 200, which manages the editing history information associated with each watch face, may check verify the NFT registration status. Nevertheless, regardless of NFT registration, creation support fund may be allocated to the original creator who created the pre-edited watch face. However, according to an example of the present disclosure, creation support fund may be allocated first to the original creator who registered a pre-edited watch face as an NFT, reflecting the original creator's intention to more actively protect the digital content created by himself or herself.

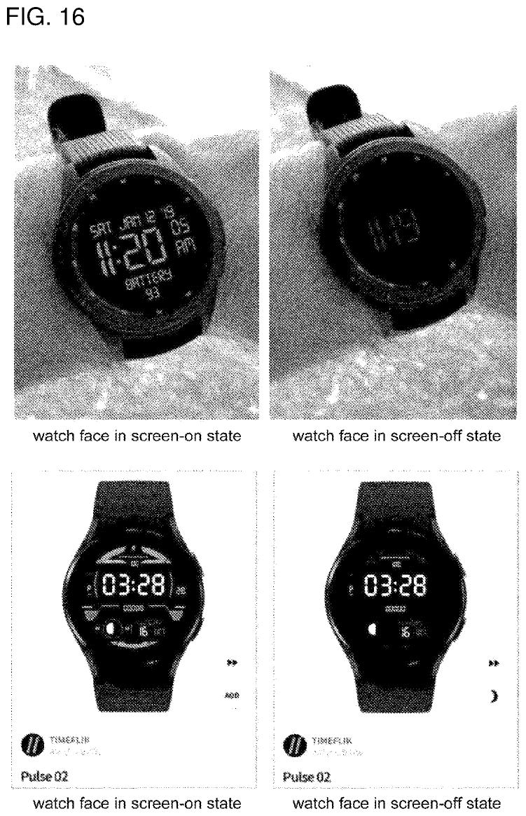

FIG. 16 illustrates a diagram showing an example of displaying different pairs of watch faces, each in a screen-on state and a screen-off state, respectively.

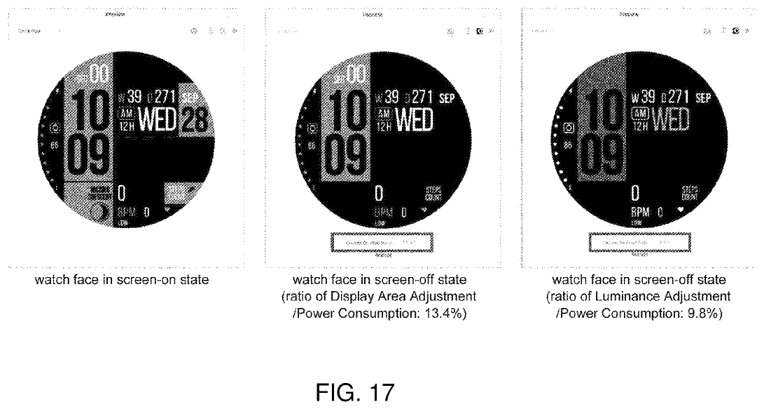

FIG. 17 illustrates a diagram showing an example of a watch face in a screen-on state and a watch face in a screen-off state, each achieved with a reduced power consumption ratios by applying different processes.

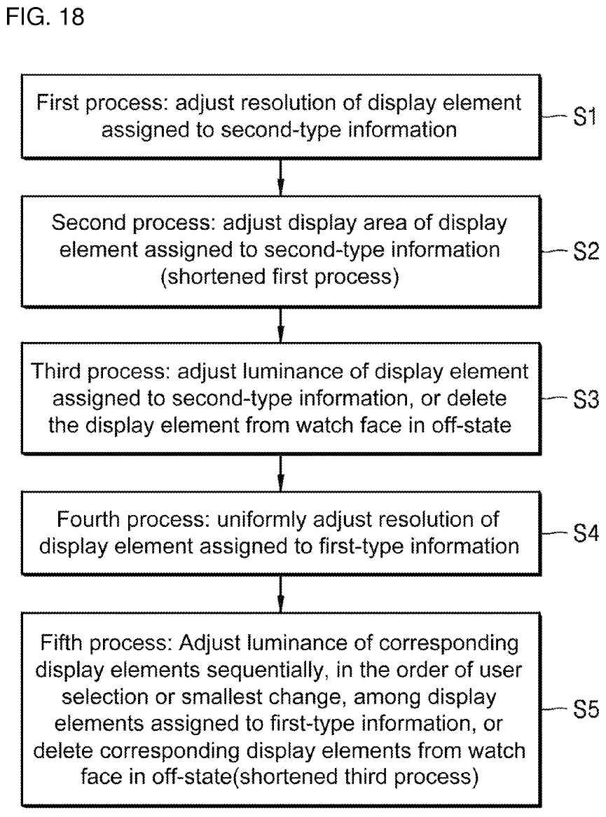

FIG. 18 illustrates a diagram showing first through fifth processes (S1 to S5) of a processing server 200 creating a watch face in a screen-off state by editing a watch face in a screen-on state.

Referring to the drawings, in an example of the present disclosure, the processing server 200 may generate a watch face in a scree-off state along with a watch face reflecting the user setting (a watch face in a screen-on state). In an example of the present disclosure, a watch face in a screen-off state may refer to a watch face that is generated on the screen of a smartwatch 300 even in the screen-off state by applying Always On Display (AOD), whereas a watch face reflecting a user setting or a watch face in a screen-on state may refer to a watch face that is generated on the screen of the smartwatch 300 in screen-on state and may be distinguished from the watch face in the screen-off state to which AOD is applied. Throughout this specification, a watch face referred to without being related to AOD may refer to a watch face in which a user setting is reflected or a watch face in a screen-on state.

In an example of the present disclosure, a watch face in a screen-off state may output a display element reflecting real-time status data even when the screen is off, and may render a display element by reflecting real-time status data, such as time, weather, health, exercise, and remaining battery capacity even when the screen is off so that a user of a smartwatch 300 may check real-time information on the screen of the smartwatch 300 without the need to turn on the screen. However, in order to apply the watch face in a screen-off state, regardless of whether the screen is turned on or not according to the user's manipulation, as a watch face in a screen-on state and a watch face in a screen-off state are continuously output on the screen of the smartwatch 300, the power consumption of the screen (display panel of the smartwatch 300) increases. In an example of the present disclosure, while providing a watch face in a screen-off state, a watch face in a screen-off state that requires relatively lower power consumption, along with a watch face in a screen-on state that requires relatively higher power consumption, may be created together in the user setting stage to create a pair of a watch face in a screen-on state and a watch face in a screen-off state so that the screen's power consumption stays below the appropriate level.

A user setting regarding a watch face according to an example of the present disclosure may include a user setting regarding a watch face in a screen-on state and a user setting regarding a watch face in a screen-off state. In an example of the present disclosure, after creating a watch face in a screen-on state through the user interface screen, a user setting for creating a watch face in a screen-off state may be additionally performed according to a request of the user. For example, in an example of the present disclosure, a user setting regarding a watch face in screen-off may be made via a user interface screen implemented on a user terminal 100 through a document or file transmitted from the processing server 200 or an application that implements a user interface screen, just like the user setting regarding a watch face in screen-on state. However, a watch face in screen-off state may be generated within the scope of a watch face in screen-on state generated through previous user setting, for example, a display element generating a watch face in screen-off state may be limited to a display element generating a watch face in screen-on state, and the user setting for a watch face in screen-off state may be limited to editing a display element in screen-on state. For example, editing a display element in screen-on state refers to editing energy factors that affect the power consumption of the screen, such as resolution, display area, or brightness of a display element that creates a watch face in screen-on state. According to an example of the present disclosure, the display element that forms a watch face in screen-off state may have a relatively lower resolution by editing of the resolution of the same display element that creates the watch face in the screen-on state. For example, a watch face in screen-off state may be generated by applying a 4×4 window (or filter) to a display element represented by a 32×32 pixel array on a watch face in screen-on state, moving the 4×4 window across the 32×32 pixel array, and taking one brightness value from the set of pixels falling within the 4×4 window (or filter), such as the average brightness value of the set of pixels falling within the 4×4 window. A display element that is displayed in a 32×32 pixel array on a watch face in screen-on state may be displayed in an 8×8 pixel array on a watch face in screen-off state, generating a watch face in screen-off state (or display element) with a reduced resolution at a ratio of ¼ from the watch face in screen-on state (or display element). With this resolution adjustment, a display element shown on a 32×32 pixel array on a watch face in screen-on may be shown on the same 32×32 pixel array on a watch face in screen-off state (the watch face in screen-on state and the watch face in screen-off state are output on substantially the same display area), but as the resolution decreases, the number of pixels turned on may be reduced at a ratio of ¼ and the power consumption of the screen (display panel) may be decreased.

In this way, in the user setting for the creation of a watch face in screen-off state, a watch face in screen-off state that reduces power consumption compared to the watch face in screen-on state may be created by adjusting the resolution of a display element displayed on the watch face in screen-on state, outputting the display element with the same display area on the watch face, and adjusting the resolution to reduce the number of pixels turned on. In the user setting for the creation of such a watch face in screen-off state, the selection of the display element subject to resolution adjustment and the reduction ratio of a specific resolution for the selected display element may be set.

In the user setting for a watch face in screen-off state, adjustment of the display area of a display element may be made along with adjustment of the resolution of the display element may be adjusted. For example, in an example of the present disclosure, adjusting the display area of a display element may output a display element displayed on the 32×32 pixel array on a watch face in screen-on state in a 24×24 pixel array on the watch face in screen-off state. For example, a watch face in screen-off state may be created by excluding a portion of the display area selected from the display element that creates a watch face in screen-on according to the user setting. In this way, adjusting the display area between the watch face in screen-on state and the watch face in screen-off state is a different process from adjusting the resolution. For example, adjusting the display area refers to make a difference in the display area where the corresponding display element is output on a watch-face in screen-on state and a watch-face in screen-off state, respectively, whereas adjusting the resolution refers to make a difference in the resolution at which the corresponding display element is output on the substantially same display area on a watch-face in screen-on state and a watch-face in screen-off state, respectively. The adjustment of the display area and resolution may contribute to the purpose of allowing the transition from the watch face in screen-on state to the watch face in screen-off state to the power saving mode or AOD mode.

In the user setting for the watch face in screen-off state, the brightness of the display element may be adjusted in addition to adjusting the resolution of the display element and the display area of the display element. For example, by adjusting a brightness value of a display element selected from the watch face in screen-on state, for example, the brightness value of R, G, B on the color space of R, G, and B, or the brightness value of Y on the color space of YCbCr, a watch face in screen-off state may be created, a watch face in screen-off state may be created, and a watch face in screen-on state with reduced power consumption to suit the power saving mode or AOD mode may be created from the watch face in screen-on state.

In this way, in an example of the present disclosure, a watch face in screen-off state that is suitable for a power saving mode may be generated by adjusting resolution, display area, or brightness from a watch face in screen-on state. The watch face in screen-on state and the watch face in screen-off state reflecting the user setting are matched to watch faces paired with each other, and a pair of watch face in screen-on state and watch face in screen-off state may be stored on a database 400 connected to the processing server 200 according to a click event of Apply button on the user interface screen. In an example of the present disclosure, a smartwatch 300 that obtains a code for creating a watch face in screen-on state and a watch face in screen-off state from the processing server 200 may output a watch face in screen-on state and a watch face in screen-off state, respectively, in response to a request of the user.

In this way, a local application that implements a user interface by obtaining documents or files from the processing server 200 or the processing server 200 calculates the pixel ratio from the watch face in screen-off state reflecting the user setting. If the calculated value is less than or equal to a criterion value through comparison between the calculated value for the Pixel Ratio and the pre-set criterion value, the creation of a watch face in screen-off state that reflects the user setting is allowed. On the other hand, if the ratio of power consumption (Pixel Ratio) calculated from the watch face in screen-off state that reflects the user setting is greater than the criterion value, the processing server 200 may provide a notification message via the user interface screen to inform that a watch face in screen-off state that reflects the user setting exceeds the criterion value for power consumption and is not permitted, and may request a reset from the user, or may perform an automatic adjustment based on the judgement of the processing server 200. As a user who sets a watch face in screen-off state, resetting the watch face in screen-off state may further reduce the Pixel Ratio calculated from the watch face in screen-off state. As the processing server 200, processes such as the first to fifth processes (S1˜S5) to be described later, which are based on automatic settings by the processing server 200 while considering user setting, may be provided as guides according to pre-set process contents in order to reduce the time required for the user setting of the watch face in screen-off state. For example, processes, such as adjusting the resolution, display area, and brightness of display elements assigned to second-type information like background, and deleting display elements assigned to status data that are less likely to change over time, may be performed.

In an example of the present disclosure, the ratio of power consumption (Pixel Ratio) may be calculated as a relative ratio of the number of pixels lit on a watch face in screen-off state among the total number of pixels forming the effective screen of the smartwatch 300 (e.g., an effective screen in which a watch face is substantially generated except for a vertical blank and a horizontal blank area in the screen of the smartwatch 300), and a criterion value for a power consumption standard, e.g., a pixel ratio, may be set to 15%. In other words, the watch face in screen-off state may determine that the Pixel Ratio in which pixels is less than or equal to 15% of the total number of pixels in the effective screen meets the power consumption criterion, and a watch face in screen-off state exceeding the power consumption criterion of 15% may be reset by the user or automatically readjusted by the processing server 200.

In an example of the present disclosure, in that AOD aims to output real-time information, e.g., information regarding real-time status data, via a watch face in screen-off state at a lower power consumption, the lower power consumption may be achieved by adjusting the display elements assigned to second-type information, which is primarily decorative design data (e.g., background), rather than adjusting the display elements assigned to first-type information, which is real-time status data. For example, the processing server 200 enable the ratio of power consumption (Pixel Ratio) calculated from a watch face in screen-off state that is automatically generated through the processing server 200 to meet the power consumption criterion by the processes, such as lowering the resolution of a display element assigned to the background independent of the real-time status data, reducing the display area by excluding some blocks of the display element assigned to the background (some of the blocks that form the background) from the background, or processing background or some blocks that actually make up the background in black without brightness values by adjusting brightness. For example, the processing server 200 performs a first process of lowering resolution (S1), a second process of reducing display area (S2), and a third process of lowering the brightness of a display element assigned to the second-type information or deleting it from a watch face in screen-off state (S3), in sequence. At the end of each process, if the ratio of power consumption (Pixel Ratio) calculated from the watch face generated as a result of each process meets the power consumption criterion, the processing server 200 may determine the watch face in screen-off that meets a power consumption criterion without performing a subsequent process. For example, even if it is a second-type information that corresponds to decorative design data, since lowering the resolution may be more advantageous in terms of user visibility to output the corresponding display element with the same display area rather than reducing the display area, the first process (S1) of lowering the resolution of the corresponding display element may take precedence over the second process (S2) of adjusting the display area. In addition, even if the resolution and display area of the display element allocated to the second-type information are reduced through the first and second processes (S1, S2), if the power consumption criterion is not met, the brightness of the corresponding display element may be substantially lowered to zero and lowered to the black level or a third process (S3) of removing the display element may be applied. In this case, a second process (S2) of reducing the display area of the corresponding display element and a third process (S3) of lowering or deleting the brightness of the corresponding display element may be continuously performed. For example, in the second process (S2) of reducing the display area, the display area of one of the display elements allocated to the background may be reduced (i.e., one of the display elements may be deleted from the display element) based on a boundary line that may be separated from each other, and if the power consumption criterion is not met and a third process (S3) follows, the brightness of the other remaining one may be reduced to a zero level based on the boundary line, effectively deleting the display element assigned to the background itself.

If the ratio of power consumption (Pixel Ratio) calculated from the adjusted watch face in screen-off state is greater than the set criterion value even after the adjustment to the display element assigned to the second-type information (e.g., background), the processing server 200 may readjust the watch face in screen-off state. For example, the fourth process (S4) of uniformly reducing the resolution of the display elements assigned to the first-type information which corresponds to status data allows for the creation of a watch face with display elements of lower resolution. The ratio of power consumption (Pixel Ratio) may be calculated from the readjusted watch face and compared to the pre-set criterion value (power consumption standard) and the status watch in screen-off state may be determined when it falls below the criterion value. However, if the ratio of power consumption of the watch face in screen-off state via readjustment of the processing server 200 still exceeds a pre-set criterion value, depending on the user's selection, a fifth process (S5) of lowering the brightness of the display element assigned to the status data that changes less over time among the display elements rendered on a watch face in screen-off state (e.g., lower it to zero and lower it to black level), or deleting the corresponding display element itself may be applied. In an example of the present disclosure, it may be understood that the process of reducing the brightness of a display element to zero to a black level is substantially the same as the process of deleting the corresponding display element. For example, in order to adjust the power consumption ratio calculated from the watch face in screen-off state (Pixel Ratio) to conform to a power consumption criterion, e.g., to bring it down to a level below a pre-set criterion value, the processing server 200 may delete the power consumption ratio calculated from the watch face in screen-off state (Pixel Ratio) in a sequence of relatively unchanging status data. For example, the processing server 200 may prioritize deleting a display element assigned to status data that changes less frequently, such as weather, over status data that changes more frequently in real time, such as time information, and may further prioritize deleting a display element assigned to status data that changes less frequently, such as date, over weather. In this way, the fourth process S4 of uniformly reducing the resolution of a display element assigned to the first-type information corresponding to real-time information takes precedence over the fifth process S5 of deleting display elements in an order of lesser change, because it may be in accordance with the user setting's purpose, with respect to the first-type information output on the smartwatch 300 according to the user's selection, to output all the first-type information by first reducing their resolutions, rather than arbitrarily deleting the first-type information by the processing server 200. In addition, in the case of deleting a display element, instead of arbitrarily deleting them by the processing server 200, the user's selection of the display elements to be deleted from the watch face in screen-off state may be requested, or the display elements may be deleted sequentially in an order with minor changes.

In an example of the present disclosure, resolution, display area, or brightness are exemplarily described as energy factors, but in various examples of the present disclosure, no adjustment to resolution may be made among the energy factors, and only the display area or brightness, excluding resolution, may be adjusted to meet the required power consumption criteria. In such an example, the first to fifth processes for meeting the criteria of power consumption as described above may be shortened to the first to third processes as follows, that is, among the first to fifth processes as described above, the first process of reducing the resolution of the display element assigned to the second-type information adjusting the resolution and the fourth process for uniformly reducing the resolution of the display element assigned to the first-type information may be omitted, and in such an example, the first to fifth processes as described above may be replaced by the first to third processes as follows. That is, the shortened first to third processes are as follows: i) a first process of reducing the display area of a display element assigned to the second-type information; ii) a second process of reducing the brightness of a display element assigned to the second-type information or removing it from a watch face in screen-off state; and iii) a third process of sequentially reducing the brightness of a corresponding display element or removing a corresponding display from the watch face in screen-off state, based on the user's selection or in order of least significant change among display elements assigned to the first-type information.

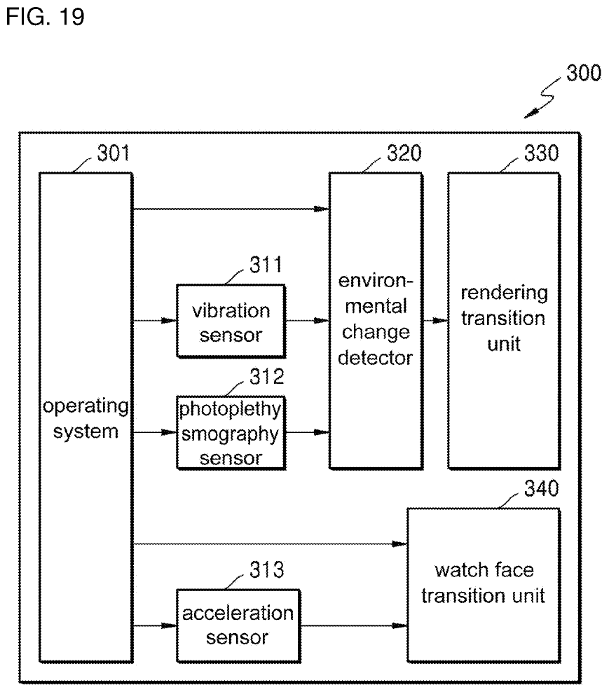

FIG. 19 illustrates a block diagram showing the overall configuration of a smartwatch according to an example of the present disclosure. Referring to FIGS. 1 and 19, configuration of a processing server 200 and a smartwatch 300 according to various examples of the present disclosure will be described below.

First, referring to FIG. 1, a processing server 200 may include, as modules connected to a web server 201 to perform respective predetermined processes (i.e., Servlet), a user interface control module 210, a content loading control module 220, a edit control module 230, and a blockchain interface module 270.

The user interface control module 210 may accept a user's request via the user interface screen and perform a response process to the user's request, e.g., implementing the user interface screen through data transmission of a document or file including a function, image data, an access path to the image data, etc., or mediating the delivery of data between the web server 201 and the database 400 to facilitate a response to the user's request.

The content loading control module 220 and the edit control module 230 may limit the loading of digital content stored in a local area for incorporation into a new display element or limit the addition of other display elements that were not present in the existing watch face in editing of the existing watch face stored in the database 400. As described above, the processing server 200 may limit the loading or addition of digital content, such as functions or executable files, with potential for interference with a set of output functions for rendering of a standardized display element provided from the processing server 200. Additionally, via the image processing module 240 described above, the processing server 200 may limit the loading or addition of relevant digital content depending on the potential infringement with a well-known brand or violations of public order and morality. The processing server 200 may distribute such functions to Servlets, such as content loading control module 220 and edit control module 230, using a web server 201 to perform the corresponding process. The blockchain interface module 270 may provide an interface for NFT registration on a watch face at a request of the user, access the blockchain network, and provide a user interface screen for NFT registration between the processing server 200 the blockchain (the blockchain's peer node), which is necessary for NFT registration, and may mediate data delivery about storage location and owner information.

In an example of the present disclosure, the first factor refers to real-time status data, which may be maintained as a variable that stores status data in a watch face where the user setting has been completed. The second factor refers to a user setting for rendering details of a display element and, once the user setting is completed on the watch face, may be constantized. However, in various examples of the present disclosure, the second factor may include a set of second factors configured in multiple to adaptively change the rendering details of the watch face in response to environmental changes. For example, display elements assigned to weather may include another set of second factors set to adapt the position and size of display elements assigned to weather to a central location and an enlarged size based on the detection of special weather conditions to enhance visibility for special weather conditions such as severe weather or alerts, e.g., to provide greater visibility for the special weather condition than a second factor set to a left position and a normal size for a normal weather condition. For example, a multiple-set second factors may be set multiple times according to a user setting or set multiple times according to the automatic setting of the processing server 200, and when a detection signal of pre-set condition is captured via an environmental change detector 320 of the watch face, the rendering details of the display element may be changed via an output function by switching from the second factor of the current setting to another second factor set to change rendering details such as the location and size of the corresponding display element. In an example of the present disclosure, the special weather condition may refer to a weather condition that may affect a user's life, such as a high temperature watch, a cold wave watch, snow, and rain, and requires appropriate preparation for the user.

In various examples of the present disclosure, for display elements for which multiple second factors regarding rendering details, including display elements assigned to weather described above, display elements assigned to exercise and health, for example, when exercise, such as walking or running, of a user is detected from a vibration sensor 311 of the watch face, in order to increase the visibility of the display element assigned to status data related to exercise and health, such as status data related to blood pressure, pulse, and electrocardiogram, another second factor that sets the position and size of the corresponding display element to a relatively central position and an enlarged size may be set, and a higher visibility, compared to the second factor set at the left position and a general size during normal times, when not exercising, may be provided. In addition, when blood pressure, pulse, or electrocardiogram detected by the photoplethysmography sensor 312 of the watch face differ from normal conditions, the second factor of the corresponding display element may be set multiple to increase the visibility of a display element assigned to health, e.g., the visibility of a display element assigned to blood pressure, heart rate, electrocardiogram.

In various examples of the present disclosure, a display element assigned to a date or time may also have a second factor that allows multiple settings for rendering details. For example, for a special date, such as an anniversary registered by a user, the second factor may be set as multiple times to increase the visibility of the display element assigned to the date. When departing overseas across the international date change line through GPS coordinates, the second factor may be set with multiple settings to increase visibility of a display element displaying status data regarding local time. As illustrated in FIG. 19, the mutual transitioning of the second factor with multiple settings may be performed based on a detection signal from the environmental change detector 320 that detects changes in the environment, and also may be carried out by a rendering transition unit 330 that takes the detection signal as input. For example, the environmental change detector 320 may detect changes in the environment based on input, such as status data regarding weather conditions, output signals from a vibration sensor 311, and output signals from a photoplethysmography sensor 312. The rendering transition unit 330 may transition the rendering details of the corresponding display element via mutual transitioning of the second factor set with multiple settings.

In various examples of the present disclosure, the watch face may be set with multiple settings to be mutually switched according to the user's body movement or according to a pre-set passage of time for mood change of the user. For example, a watch face set with multiple settings may be set with multiple settings according to a user setting as described above, and a group of watch faces set with multiple settings may be mutually transitioned according to a pre-set transitioning condition.

According to an example of the present disclosure, a multi-set watch face may be mutually switched according to the shaking direction of the wrist detected from an acceleration sensor 313 of the smart watch 300, and may include, for example, a plurality of watch faces that are cyclically switched according to the rotation direction of the wrist. In an example of the present disclosure, the acceleration sensor 313 of the smart watch 300 may recognize the forward direction and the reverse direction separately, and a watch face set with multiple times may be circulated while moving forward or backward according to the forward direction and the reverse direction.

For example, in an example of the present disclosure, the watch face may include a switch condition monitoring unit that informs the start of the transition and the direction of the transition as a condition for transitioning the watch face from the output of the acceleration sensor 313 or status data regarding the current time, and a watch face transition unit 340 that interchanges multiple-set watch faces according to a signal from the transition condition monitoring unit.

In an example of the present disclosure, the watch face transition unit 340 may interchange a multiple-set watch face with daytime watch faces and nighttime watch faces over time based on a pre-set transition condition. For example, during nighttime hours, which generally offer more flexibility than the allocated work hours during the day, transitioning to a vibrant-colored or high-bright nighttime watch face based on individual preferences may provide users with an opportunity for a mood shift, offering enjoyment through interactions such as changes triggered by body movements or the passage of time, ultimately enhancing overall user satisfaction.

The present disclosure has been described with reference to the examples shown in the accompanying drawings, which are exemplary only, and one of those skilled in the art to which the invention belongs will understand that various modifications and equivalent examples are possible.

### INDUSTRIAL APPLICABILITY

The present disclosure may be applied to a watch face of a smartwatch or a user interface for creating a watch face.

What is claimed is:

1. A watch face creation system, comprising:
a processing server providing a user interface for selecting a type of information rendered on a watch face, including first-type information corresponding to real-time status data and second-type information corresponding to design data, and for selecting a display element assigned to a selected type of information,
wherein the processing server outputs a display element reflecting real-time status data on a user interface screen via a set of output functions that includes a first output function of outputting a first parameter by using the status data as a first factor and a second output function of outputting rendering of a display element by using a user's setting value regarding detailed design of the display element assigned to the real data; and
regarding a code including a set of output functions constantizing the second factor,
i) converts the code according to a smartwatch in associated with a user's ID and transmits the converted code to the smartwatch; and ii) stores the code in a database in associated with a user's ID.

2. The watch face creation system of claim 1,
wherein the processing server does a watch face that has been set by the user as a watch face in a screen-on state, and in response to the user's request, additionally creates a watch face in a screen-off state paired with the watch face in a screen-on state

3. The watch face creation system of claim 2,
wherein the processing server adjusts an energy factor of display area or luminance that affects a screen's power consumption from the watch face in a screen-on state to create a watch face in a screen-off state adjusted to meet a pre-set power consumption criterion, and
wherein the power consumption criterion is set as ratio of a number of pixels turned on the watch face in the screen-off state among a total number of pixels on an effective screen of a smartwatch where a watch face is rendered.′

4. The watch face creation system of claim 3,
wherein the processing server preferentially adjusts an energy factor of display area or luminance of a corresponding display element based on a type of information assigned to respective a plurality of display elements forming a watch face,
and preferentially adjusts, among display elements assigned first-type information corresponding to real-time status data and second-type information corresponding to design data, a display element assigned to the second-type information before adjusting a display element assigned to the first-type information to create a watch face in a screen-off state that meets power consumption criterion.

5. The watch face creation system of claim 4,
wherein the processing server sequentially applies first through third processes to create a watch face in a screen-off state that meets power consumption criterion and determines whether to meet the power consumption criterion upon completion of each process:
i) first process of reducing a display area of a display element assigned to the second-type information;
ii) second process of reducing luminance of the display element assigned to the second-type information or removing from the watch face in a screen-off state; and
iii) third process of sequentially reducing luminance of a corresponding display element or removing from the watch face in a screen-off state, according to the user's selection or in order of least change over time among display elements assigned to the first-type information.
